(19) United States
(12) Patent Application Publication
(10) Pub. No.: US 2024/0365317 A1
(43) Pub. Date: Oct. 31, 2024

(54) COMMUNICATION METHODS, AND DEVICE

(71) Applicant: GUANGDONG OPPO MOBILE TELECOMMUNICATIONS CORP., LTD., Dongguan (CN)

(72) Inventors: Zhe LIU, Dongguan (CN); Zhihua SHI, Dongguan (CN); Yun FANG, Dongguan (CN); Wenhong CHEN, Dongguan (CN); Yingpei HUANG, Dongguan (CN)

(21) Appl. No.: 18/772,044

(22) Filed: Jul. 12, 2024

Related U.S. Application Data
(63) Continuation of application No. PCT/CN2022/075230, filed on Jan. 30, 2022.

(51) Int. Cl. H04W 72/1268; H04L 5/00; H04W 72/232

(52) U.S. Cl. CPC H04W 72/1268; H04L 5/0012; H04W 72/232

(57) ABSTRACT

Provided is a communication method. The method includes: transmitting, by a terminal device, at least one uplink information on at least one resource; wherein the at least one resource comprises at least one of: a time domain resource, a frequency domain resource, a code domain resource, or a spatial domain resource; and the at least one uplink information comprises at least one of: one or more physical uplink control channels (PUCCHs), one or more physical uplink shared channels (PUSCHs), one or more transmission layers, one or more transmission layers corresponding to the PUSCHs, one or more redundancy versions (RVs) corresponding to the PUSCHs, one or more transport blocks, one or more RVs corresponding to the transport blocks, or one or more reference signals.

### CROSS-REFERENCE TO RELATED APPLICATION

This application is a continuation of International Application No. PCT/CN2022/075230, filed Jan. 30, 2022, the entire disclosure of which is incorporated herein by reference.

### TECHNICAL FIELD

Embodiments of the present disclosure relate to the technical field of mobile communications, and in particular, relate to a communication method and apparatus, and a device, a chip, a storage medium, a product and a program.

### BACKGROUND

The 5^{th} generation (5G) communication system covers three major types of scenarios, including enhanced mobile broadband (eMBB), massive machine type communication (mMTC), and ultra-reliable and low-delay communication (URLLC). eMBB service further improves the performance of user experience based on the existing mobile broadband service scenarios. For example, eMBB is applicable to high-traffic mobile broadband services such as three-dimensional (3D) or ultra-high-definition video services; mMTC is applicable to large-scale Internet of things (IoT) services; and URLLC is applicable to services requiring low-delay and high-reliability connection, such as unmanned vehicles or industrial automation.

### SUMMARY

Embodiments of the present disclosure provide a communication method and apparatus, a device, a chip, a storage medium, a product and a program.

Some embodiments of the present disclosure provide a communication method.

The method includes: transmitting, by a terminal device, at least one uplink information on at least one resource.

The at least one resource includes at least one of: a time domain resource, a frequency domain resource, a code domain resource, or a spatial domain resource.

The at least one uplink information includes at least one of: one or more physical uplink control channels (PUCCHs), one or more physical uplink shared channels (PUSCHs), one or more transmission layers corresponding to the PUCCHs, one or more transmission layers corresponding to the PUSCHs, one or more redundancy versions (RVs) corresponding to the PUSCHs, one or more transport blocks, one or more RVs corresponding to the transport blocks, or one or more reference signals.

Some embodiments of the present disclosure provide a terminal device. The terminal device includes a processor and a memory configured to store at least one computer program. The processor, when loading and running the at least one computer program stored in the memory, is caused to perform the method as described above.

Some embodiments of the present disclosure provide a network device. The network device includes a processor and a memory configured to store at least one computer program. The processor, when loading and running the at least one computer program stored in the memory, is caused to: receive at least one uplink information on at least one resource; wherein the at least one resource comprises at least one of: a time domain resource, a frequency domain resource, a code domain resource, or a spatial domain resource; and the at least one uplink information comprises at least one of: one or more physical uplink control channels (PUCCHs), one or more physical uplink shared channels (PUSCHs), one or more transmission layers corresponding to the PUCCHs, one or more transmission layers corresponding to the PUSCHs, one or more redundancy versions (RVs) corresponding to the PUSCHs, one or more transport blocks, one or more RVs corresponding to the transport blocks, or one or more reference signals.

### BRIEF DESCRIPTION OF DRAWINGS

The accompanying drawings illustrated herein are used to provide a further understanding of the present disclosure and form part of the present disclosure, and the exemplary embodiments of the present disclosure and the description thereof are used to explain the present disclosure and do not constitute any limitation to the present disclosure. In the accompanying drawings:

FIG. 1 is a schematic diagram of an application scenario according to some embodiments of the present disclosure;

FIG. 2 is a schematic diagram of an uplink transmission according to some embodiments of the present disclosure;

FIG. 3 is a schematic flowchart of a communication method according to some embodiments of the present disclosure;

FIG. 4 is a schematic diagram of a first resource set and a second resource set according to some embodiments of the present disclosure;

FIG. 5 is a schematic diagram of another first resource set and second resource set according to some embodiments of the present disclosure;

FIG. 6 is a schematic diagram of yet another first resource set and second resource set according to some embodiments of the present disclosure;

FIG. 7 is a schematic diagram of still yet another first resource set and second resource set according to some embodiments of the present disclosure;

FIG. 8 is a schematic diagram of a first resource set and second a second resource set according to some other embodiments of the present disclosure;

FIG. 9 is a schematic diagram of a first resource set and a second resource set according to some other embodiments of the present disclosure;

FIG. 10 is a schematic diagram of a starting RB location of a first frequency hopping resource to a fourth frequency hopping resource according to some embodiments of the present disclosure;

FIG. 11 is a schematic diagram of a starting RB location of a first resource and a second resource according to some embodiments of the present disclosure;

FIG. 12 is a schematic diagram of a resource distribution according to some embodiments of the present disclosure;

FIG. 13 is a schematic flow diagram of another communication method according to some embodiments of the present disclosure;

FIG. 14 is a schematic structural diagram of a communication apparatus according to some embodiments of the present disclosure;

FIG. 15 is a schematic structural diagram of another communication apparatus according to some embodiments of the present disclosure;

FIG. 16 is a schematic structural diagram of a communication device according to some embodiments of the present disclosure; and

FIG. 17 is a schematic structural diagram of a chip according to some embodiments of the present disclosure.

### DETAILED DESCRIPTION

The technical solutions according to the embodiments of the present disclosure are described hereinafter in conjunction with the accompanying drawings in the embodiments of the present disclosure. Apparently, the described embodiments are a part but not all of the embodiments of the present disclosure. Based on the embodiments in the present disclosure, all other embodiments derived by those skilled in the art without creative efforts fall within the scope of protection of the present disclosure.

The technical solutions according to the embodiments of the present disclosure may be arbitrarily combined without conflict. In the description of the present disclosure, the term “a plurality of” indicates two or more, unless otherwise expressly and specifically limited.

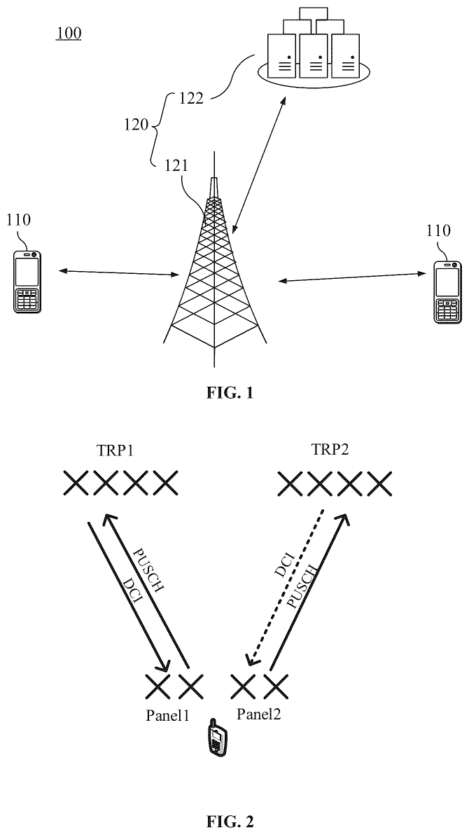

FIG. 1 is a schematic diagram of an application scenario according to some embodiments of the present disclosure. As shown in FIG. 1, the communication system 100 includes a terminal device 110 and a network device 120. The network device 120 communicates with the terminal device 110 over an air interface. Multi-service transmission is supported between the terminal device 110 and the network device 120.

It should be understood that description is given in the embodiments of the present disclosure only using the communication system 100 as an example, but the embodiments of the present disclosure are not limited thereto. That is, the technical solutions according to the embodiments of the present disclosure are applicable to a variety of communication systems, such as a long-term evolution (LTE) system, an LTE time division duplex (TDD) system, a universal mobile telecommunication system (UMTS), and an Internet of things (IoT) system, a narrow band IoT (NB-IoT) system, an enhanced machine-type communication (eMTC) system, a 5G communication system (also referred to as a new radio (NR) communication system), or a future communication systems (e.g., 6G, 7G communication systems).

In the communication system 100 shown in FIG. 1, the network device 120 is an access network device that communicates with the terminal device 110. The access network device provides communication coverage for a specific geographical region and communicates with terminal devices 110 within the coverage region.

The terminal device is referred to as a user equipment (UE), a mobile station (MS), a mobile terminal (MT), a subscriber unit, a subscriber station, a remote station, a remote terminal, a mobile device, a user terminal, a terminal, a wireless communication device, a user agent, or a user device. The terminal device is any device capable of communicating with the access network device. Terminal devices include one of or a combination of at least two of: a personal digital assistant (PDA), a handheld device with a wireless communication function, a computing device or other processing devices connected to a wireless modem, a server, a mobile phone, a pad, a computer with a wireless transceiver function, a palmtop computer, a desktop computer, a portable media player, a smart speaker, a navigation device, a wearable device such as a smart watch, smart glasses, a smart necklace, and a pedometer, a digital TV, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, as well as a car, an in-vehicle device, an in-vehicle module, a wireless modem, a handheld, a customer premise terminal equipment (CPE), or a smart home appliance.

The network device in the embodiments of the present disclosure includes an access network device 121 and/or a core network device 122.

The access network device 121 includes one of or a combination of at least two of the following: an evolved NodeB (eNB or eNodeB) in an LTE system, a next generation radio access network (NG RAN) device, and a gNB in an NR system, a small station, a micro station, a wireless controller in a cloud radio access network (CRAN), a wireless-fidelity (Wi-Fi) access point, a transmission and reception point (TRP), a relay station, an access point, an in-vehicle device, a wearable device, a hub, a switch, a bridge, a router, or a network device in an evolved public land mobile network (PLMN).

The core network device 122 is a 5G core (5GC) device, and the core network device 122 includes one of or a combination of at least two of: an access and mobility management function (AMF), an authentication server function (AUSF), a user plane function (UPF), a session management function (SMF), a location management function (LMF), or a policy control function (PCF). In some other embodiments, the core network device is an evolved packet core (EPC) device of the LTE network, such as a session management function+core packet gateway (SMF+PGW-C) device. It should be understood that SMF+PGW-C is capable of achieving the functions that SMF and PGW-C achieve at the same time. The above-described core network device 122 may be referred to as other names during network evolution, or that new network entities are formed by dividing the functions of the core network, which are not limited in the embodiments of the present disclosure.

The various functional units in the communication system 100 communicate with each other by establishing a connection over a next generation (NG) interface. For example, the terminal device establishes an air interface connection to the access network device over an NR interface for transmitting user-plane data and control-plane signaling. The terminal device establishes a control-plane signaling connection to the AMF over an NG interface 1 (N1 for short). The access network device, such as a next-generation wireless access base station (g NodeB or gNB), establishes a user-plane data connection to the UPF over an NG interface 3 (N3 for short). The access network device establishes a control-plane signaling connection to the AMF over an NG interface 2 (N2 for short). The UPF establishes a control-plane signaling connection to the SMF over an NG interface 4 (N4 for short). The UPF interacts with the data network for user-plane data over an NG interface 6 (N6 for short). The AMF establishes a control-plane signaling connection to the SMF over an NG interface 11 (N11 for short). The SMF establishes a control-plane signaling connection to the PCF over an NG interface 7 (N7 for short).

FIG. 1 exemplarily illustrates a base station, a core network device, and two terminal devices. In some embodiments, the wireless communication system 100 includes a plurality of base station devices, and each base station covers other numbers of terminal devices, which is not limited in the embodiments of the present disclosure.

It should be noted that FIG. 1 illustrates, by way of example only, a system to which the present disclosure is applicable, but of course, the methods according to the embodiments of the present disclosure may be applicable to other systems. In addition, the terms “system” and “network” are often used interchangeably herein. The term “and/or” merely describes an association relationship of associated objects, and indicates three types of relationships. For example, the phrase “A and/or B” means (A), (B), or (A and B). In addition, the symbol “/” herein usually indicates an “or” relationship between the associated objects. It should also be understood that the term “indicate” mentioned in the embodiments of the present disclosure may be a direct indication, an indirect indication, or an indication that there is an associated relationship. For example, A indicates B means that A indicates B directly, e.g., B may be acquired by A; or that A indicates B indirectly, e.g., A indicates C by which B may be acquired; or that an association is present between A and B. It should also be understood that the term “correspond” mentioned in the embodiments of the present disclosure may refer to a direct correspondence or an indirect correspondence that is present between two items, may refer to an association that is present between two items, or may refer to another relationship such as indicating and being indicated, or configuring and being configured. It should also be understood that the term “predefined,” “defined in a protocol,” “predetermined,” or “predefined rule” referred to in the embodiments of the present disclosure may be achieved by storing a corresponding code, form, or other means that may be used to indicate relevant information in a device (e.g., including a terminal device and a network device) in advance, and the specific ways of implementation are not limited in the present disclosure. For example, “predefined” means “defined in a protocol.” It should also be understood that, in the embodiments of the present disclosure, the “protocol” refers to a standard protocol in the field of communication, such as an LTE protocol, an NR protocol, and relevant protocols applied in future communication systems, which may be not limited in the present disclosure.

The channel propagation characteristics between the multiple transmission points and the terminal device are relatively independent, and repeated transmission in the air, time, and frequency domains using multiple TRPs improves the reliability of data transmission and reduces the transmission delay. For the ideal backhaul scenario, physical downlink shared channel (PDSCH) transmissions of multiple TRPs are scheduled by single downlink control information (DCI), and the multiple PDSCH transmissions are at least one of frequency division multiplexing (FDM), spatial division multiplexing (SDM), or time division multiplexing (TDM).

In the FDM scheme, a codepoint of the DCI field ‘transmission configuration indication (TCI)’ indicates two TCI states, and the DCI field ‘antenna port(s)’ indicates a demodulation reference signal (DMRS) port in the same code division multiplexing (CDM) group. The precoding granularity may be represented by contiguous resource blocks (RBs) in the frequency domain. For example, the precoding granularity is wideband, 2 RBs or 4 RBs.

In some embodiments, the precoding granularity is wideband,

$$⌈ \frac{{n}_{PRB}}{2} ⌉$$

physical resource block (PRB) is allocated to the first TCI state, the remaining

$$⌊ \frac{{n}_{PRB}}{2} ⌋$$

PRB is allocated to the second TCI state, and n_{PRB} is the total number of PRBs allocated to the terminal device.

In some embodiments, the precoding granularity is 2 RBs or 4 RBs, an even-indexed precoding resource block group (PRG) is allocated to the first TCI state, and an odd-indexed PRG is allocated to the second TCI state. Except for the first PRG and the last PRG, the number of RBs included in other PRGs is the same as the precoding granularity. The number of RBs included in the first and last PRGs is greater than or equal to 1 and less than or equal to the precoding granularity.

In the SDM scheme, two groups of data layers corresponding to the same transport block are transmitted by different TRPs and transmitted at the same time-frequency resources. Each TRP uses a different group of DMRS ports.

In some embodiments, the multiple TRPs share a codeword.

In some embodiments, due to the differences in the large-scale channel characteristics of the respective TRPs, to ensure orthogonality between DMRS ports within the same CDM group, it is required that the DMRS ports of the same CDM group are quasi-co-located (QCL). Therefore, when designing a DMRS port allocation scheme collaboratively transmitted by multi-TRPs, it is necessary to support port allocation for at least two CDM groups. That is, one CDM group is used for data transmission of one TRP. The combinations of the transmission layers for the two TRPs include {1, 1}, {1, 2}, and {2, 2}.

In some embodiments, in the case that the TCI domain indicated in the DCI indicates 2 TCI states, the data associated with the first TCI state is transmitted using the DMRS port indicated by the first CDM group, and the data associated with the second TCI state is transmitted using the DMRS port indicated by the second CDM group.

For uplink multi-panel/TRP transmission, in the case that the terminal is configured with a plurality of panels and supports simultaneous transmission of uplink information on the plurality of panels, multiple uplink information is transmitted on the plurality of panels at the same time, such that the spectral efficiency of the uplink is improved. Similarly, the uplink transmissions of the multiple panels/TRP are scheduled by a single DCI or multiple DCI.

For a better understanding of the embodiments of the present disclosure, the TCI state of the downlink signal transmission relevant to the present disclosure is described hereinafter.

In the NR system, the network device configures a corresponding TCI state for each downlink signal or downlink channel, which indicates a QCL reference signal corresponding to a target downlink signal or a target downlink channel, such that the terminal is capable of receiving the target downlink signal or the target downlink channel based on the reference signal.

One TCI state includes the following configurations:
a TCI state ID, configured to identify a TCI state;
QCL information 1; and
QCL information 2.

QCL information includes the following information:
a QCL type configuration, which is one of QCL type A, QCL type B, QCL type C, or QCL type D; and
a QCL reference signal configuration, including a cell ID where the reference signal is located, a bandwidth part (BWP) ID and an identifier of the reference signal (which is a channel state information reference signal (CSI-RS) resource ID or a synchronization signal block (SSB) index).

The QCL type of at least one of the QCL information 1 or the QCL information 2 is one of typeA, typeB, or typeC. The QCL type of the other QCL information (if configured) is QCL type D.

Different QCL type configurations are defined as follows:
‘QCL-TypeA’: {Doppler shift, Doppler spread, average delay, delay spread};
‘QCL-TypeB’: {Doppler shift, Doppler spread};
‘QCL-TypeC’: {Doppler shift, average delay}; and
‘QCL-TypeD’: {Spatial Rx parameter}.

In the case that the network device configures the QCL reference signal of the target downlink channel to be the reference SSB or the reference CSI-RS resource by the TCI state and the QCL type configuration is typeA, typeB, or typeC, the terminal device assumes that a target large scale parameter of the target downlink channel is the same as that of the reference SSB or reference CSI-RS resource, and thus the terminal device performs reception based on the same corresponding reception parameter. The target large scale parameter is determined based on QCL type configuration. Similarly, in the case that the network device configures the QCL reference signal of the target downlink channel to be the reference SSB or reference CSI-RS resource by the TCI state and the QCL type configuration is type D, the terminal device receives the target downlink channel based on the same receive beam (i.e., spatial Rx parameter) as for receiving the reference SSB or reference CSI-RS resource. Typically, the target downlink channel and its reference time synchronization signal/physical broadcast channel (SSB/PBCH) or reference CSI-RS resource are transmitted by the same TRP, the same antenna panel, or the same beam on the network side. In the case that the two downlink signals or downlink channels are transmitted by different TRPs, panels, or beams, different TCI states are usually configured.

For the downlink control channel, the TCI state is indicated by radio resource control (RRC) signaling or RRC signaling combined with MAC signaling. For the downlink data channel, the set of available TCI states is indicated by RRC signaling, and some of these TCI states are activated by medium access control (MAC) layer signaling, and finally one or two TCI states are indicated from the activated TCI states by a TCI state indication field in the DCI for the PDSCH scheduled by the DCI.

In the communication process, how to reduce the delay of uplink information transmission and improve the throughput or reliability of uplink information transmission is an ongoing concern in the field.

FIG. 2 is a schematic diagram of an uplink transmission according to some embodiments of the present disclosure, as shown in FIG. 2, the terminal device transmits, based on the DCI transmitted by the TRP 1, a PUSCH to the TRP 1 and the TRP 2 by a panel 1 and a panel 2 respectively, or the terminal device transmits, based on the DCI transmitted by the TRP 1 and the DCI transmitted by the TRP 2, the PUSCH to the TRP 1 and the TRP 2 by the panel 1 and the panel 2 respectively.

In related art, multi-TRP transmission schemes for downlink, multi-TRP transmission schemes for uplink with single DCI scheduling, or TDM time division multiplexing schemes of PUCCH and PUSCH are provided.

However, for the multi-TRP/Panel transmission scheme for uplink PUCCH or PUSCH, there is the TDM scheme in the related art, and to further reduce the delay of the transmission, the multi-TRP/Panel transmission scheme for transmitting PUCCH/PUSCH by at least one of the FDM, the SDM, or CDM is considered.

The panel in embodiments of the present disclosure is a logical entity used by the terminal device for transmission, and the transmit beams of antennas at different panels are independently adjusted.

The technical solutions of the present disclosure are described in detail hereinafter by specific embodiments, and the above solutions as optional solutions are combined with any of the following technical solutions according to the embodiments of the present disclosure.

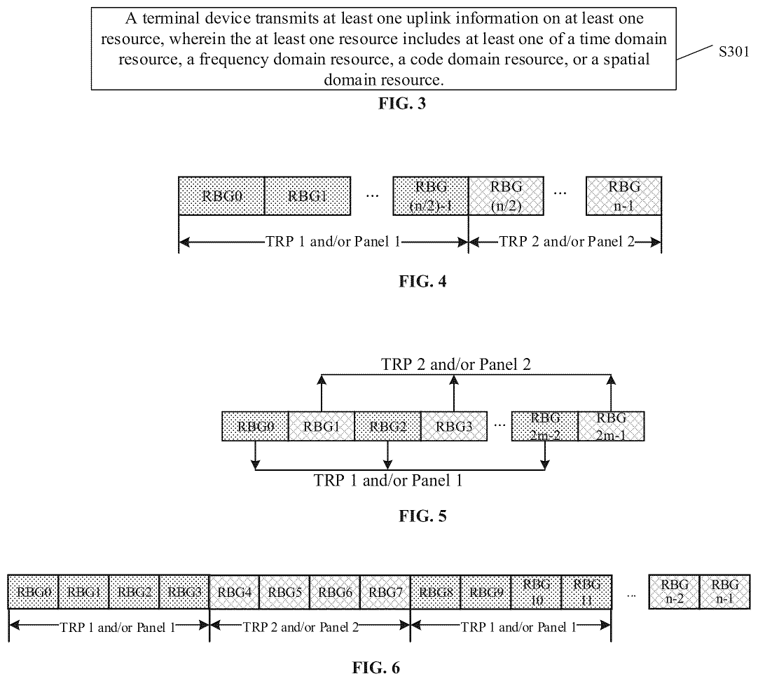

FIG. 3 is a flowchart diagram of a communication method according to some embodiments of the present disclosure. As shown in FIG. 3, the method includes the following processes.

In S301, a terminal device transmits at least one uplink information on at least one resource.

The at least one resource includes at least one of: a time domain resource, a frequency domain resource, a code domain resource, or a spatial domain resource.

The at least one uplink information includes at least one of: one or more PUCCHs, one or more PUSCHs, one or more transmission layers corresponding to the PUCCHs, one or more transmission layers corresponding to the PUSCHs, one or more RVs corresponding to the PUSCHs, one or more transport blocks, one or more RVs corresponding to the transport blocks, or one or more reference signals.

In some embodiments, the one or more reference signals include one or more DMRSs and one or more sounding reference signals (SRSs).

In some embodiments, the terminal device determines at least one resource, and the terminal device transmits at least one uplink information on the at least one resource.

In some embodiments, the time domain resources are contiguous or non-contiguous time domain resources. The number of time domain resources is at least one. In some embodiments, the frequency domain resource is a contiguous or non-contiguous frequency domain resource. The number of frequency domain resources is at least one. In some embodiments, the number of code domain resources is at least one. In some embodiments, the number of spatial domain resources is at least one.

In some embodiments, the one or more transmission layers are configured to transmit the PUCCH. In some embodiments, the one or more transmission layers are configured to transmit the PUSCH. In some embodiments, the one or more transmission layers are configured to transmit the PUCCH and PUSCH. For example, in the case that the plurality of transmission layers are configured to transmit the PUCCH and PUSCH, one portion of the transmission layers are configured to transmit the PUCCH, and another portion of the transmission layers are configured to transmit the PUSCH, or each of at least some transmission layers of the plurality of transmission layers is configured to transmit both the PUCCH and PUSCH. For example, each of the plurality of transmission layers is configured to transmit both the PUCCH and PUSCH.

For example, the one or more transmission layers include two PUSCH transmission layers.

In some embodiments, the one or more transmission layers corresponding to the PUSCH are referred to as one or more PUSCH transmission layers. The one or more RVs corresponding to the PUSCHs are referred to as one or more PUSCH RVs. The one or more RVs corresponding to the transport blocks are referred to as one or more transport block RVs.

In some embodiments, the one or more transmission layers are configured to transmit not only the PUCCH and/or the PUSCH, but also information other than the PUCCH and the PUSCH.

In some embodiments, the at least one piece of information includes one or more RVs corresponding to the PUSCH and the PUSCH. The plurality of RVs are different RVs. In some embodiments, the at least one piece of information includes one or more RVs corresponding to the PUSCH. In some embodiments, the one or more transmission layers are configured to transmit the one or more RVs corresponding to the PUSCHs. For example, one transmission layer is capable of transmitting one RV corresponding to the PUSCH. As another example, one transmission layer is capable of transmitting a plurality of RVs corresponding to the PUSCH.

In some embodiments, the one or more transmission layers are configured to transmit one or more transport blocks. For example, one transmission layer is capable of transmitting a plurality of transport blocks. As another example, one transmission layer is configured to transmit a single transport block.

In some embodiments, the one or more transmission layers are configured to transmit one or more RVs corresponding to the transport block. For example, one transmission layer is configured to transmit a plurality of RVs corresponding to the transport block. As another example, one transmission layer is configured to transmit one RV corresponding to the transport block.

In some embodiments, the one or more transmission layers are configured to transmit one or more reference signals. For example, one transmission layer is configured to transmit a plurality of different reference signals. Exemplarily, one transmission layer is configured to transmit the DMRS and the SRS. As another example, one transmission layer is configured to transmit one reference signal. Exemplarily, in the case that there are two transmission layers, one of the transmission layers is configured to transmit the DMRS, and the other transmission layer is configured to transmit the SRS, both the two transmission layers are configured to transmit the DMRS, or both the two transmission layers are configured to transmit the SRS.

In some embodiments, different PUCCHs are transmitted on the same time domain resource, different PUCCHs are transmitted on the same frequency domain resource, different PUCCHs are transmitted on the same code domain resource, or different PUCCHs are transmitted on the same spatial domain resource. In some other embodiments, different PUCCHs map different time domain resources, different PUCCHs map different frequency domain resources, different PUCCHs map different code domain resources, or different PUCCHs map different spatial domain resources.

In some embodiments, different PUSCHs are transmitted on the same time domain resource, different PUSCHs are transmitted on the same frequency domain resource, different PUSCHs are transmitted on the same code domain resource, or different PUSCHs are transmitted on the same spatial domain resource. In some other embodiments, different PUSCHs map different time domain resources, different PUSCHs map different frequency domain resources, different PUSCHs map different code domain resources, or different PUSCHs map different spatial domain resources.

In some embodiments, different transmission layers corresponding to the PUCCH are transmitted on the same time domain resource, different transmission layers corresponding to the PUCCH are transmitted on the same frequency domain resource, different transmission layers corresponding to the PUCCH are transmitted on the same code domain resource, or different transmission layers corresponding to the PUCCH are transmitted on the same spatial domain resource. In some other embodiments, different transmission layers corresponding to the PUCCH map different time domain resources, different transmission layers corresponding to the PUCCH map different frequency domain resources, different transmission layers corresponding to the PUCCH map different code domain resources, or different transmission layers corresponding to the PUCCH map different spatial domain resources.

In some embodiments, different transmission layers corresponding to the PUSCH are transmitted on the same time domain resource, different transmission layers corresponding to the PUSCH are transmitted on the same frequency domain resource, different transmission layers corresponding to the PUSCH are transmitted on the same code domain resource, or different transmission layers corresponding to the PUSCH are transmitted on the same spatial domain resource. In some other embodiments, different transmission layers corresponding to the PUSCH map different time domain resources, different transmission layers corresponding to the PUSCH map different frequency domain resources, different transmission layers corresponding to the PUSCH map different code domain resources, or different transmission layers corresponding to the PUSCH map different spatial domain resources.

In some embodiments, different RVs corresponding to the PUSCH are transmitted on the same time domain resource, different RVs corresponding to the PUSCH are transmitted on the same frequency domain resource, different RVs corresponding to the PUSCH are transmitted on the same code domain resource, or different RVs corresponding to the PUSCH are transmitted on the same spatial domain resource. In some other embodiments, different RVs corresponding to the PUSCH map different time domain resources, different RVs corresponding to the PUSCH map different frequency domain resources, different RVs corresponding to the PUSCH map different code domain resources, or different RVs corresponding to the PUSCH map different spatial domain resources.

In some embodiments, different transport blocks are transmitted on the same time domain resource, different transport blocks are transmitted on the same frequency domain resource, different transport blocks are transmitted on the same code domain resource, or different transport blocks are transmitted on the same spatial domain resource. In some other embodiments, different transport blocks map different time domain resources, different transport blocks map different frequency domain resources, different transport blocks map different code domain resources, or different transport blocks map different spatial domain resources.

In some embodiments, different RVs corresponding to the transport blocks are transmitted on the same time domain resource, different RVs corresponding to the transport blocks are transmitted on the same frequency domain resource, different RVs corresponding to the transport blocks are transmitted on the same code domain resource, or different RVs corresponding to the transport blocks are transmitted on the same spatial domain resource. In some other embodiments, different RVs corresponding to the transport blocks map different time domain resources, different RVs corresponding to the transport blocks map different frequency domain resources, different RVs corresponding to the transport blocks map different code domain resources, or different RVs corresponding to the transport blocks map different spatial domain resources.

In some embodiments, different reference signals are transmitted on the same time domain resource, different reference signals are transmitted on the same frequency domain resource, different reference signals are transmitted on the same code domain resource, and different reference signals are transmitted on the same spatial domain resource. In some other embodiments, different reference signals map different time domain resources, different reference signals map different frequency domain resources, different reference signals map different code domain resources, or different reference signals map different spatial domain resources.

In some embodiments of the present disclosure, the terminal device transmits at least one uplink information on at least one resource. The at least one resource includes at least one of: a time domain resource, a frequency domain resource, a code domain resource, or a spatial domain resource. The at least one uplink information includes one of: one or more PUCCHs, one or more PUSCHs, one or more transmission layers corresponding to the PUCCHs, one or more transmission layers corresponding to the PUSCHs, one or more RVs corresponding to the PUSCHs, one or more transport blocks, one or more RVs corresponding to the transport blocks, or one or more reference signals. In this way, the terminal device is capable of transmitting the uplink information on at least one of the time domain resource, the frequency domain resource, the code domain resource, or the spatial domain resource, and hence is capable of transmitting information on at least one resource dimension, such that the delay of the transmission of the uplink information is reduced, and the throughput or reliability of the transmission of the uplink information is improved.

For example, in the case that the at least one uplink information is transmitted on a plurality of frequency domain resources and/or a plurality of code domain resources and/or a plurality of spatial domain resources, more information is transmitted at one or more time units, such that the delay of the uplink information transmission is reduced, and thus the throughput of the uplink information transmission is improved. As a further example, in the case that duplicate uplink information is transmitted on at least one resource, the reliability of the uplink information transmission is improved. The time unit is a symbol, a time slot, a subframe, a time window, or the like.

In some embodiments, the at least one resource configured to transmit the at least one uplink information is scheduled by one or more DCI, or the at least one resource configured to transmit the at least one uplink information is configured by higher layer signaling.

In some embodiments, different DCIs are transmitted by the same TRP. In some other embodiments, different DCIs are transmitted by different TRPs

In some embodiments, the higher layer signaling is configured by the network device to the terminal device. In some other embodiments, the higher layer signaling is configured by a higher layer of the terminal device.

In some embodiments, different uplink information in the at least one uplink information is associated with different spatial information.

The spatial information includes at least one of: antenna panel information, TRP information, control resource set (CORESET) group information, reference signal set information, TCI state information, beam information, or capability set information.

For example, in some embodiments, the spatial information is one of the antenna panel information, the TRP information, the CORESET group information, the reference signal set information, the TCI state information, the beam information, or the capability set information. As another example, the spatial information includes the antenna panel information and the TRP information, or the spatial information includes the antenna panel information, TRP information, and the reference signal set information. The contents of the spatial information are not listed herein, and the embodiments of the present disclosure do not place any limitations on the contents that may be included in the spatial information.

In some embodiments, the antenna panel information includes at least one of an antenna panel ID or an antenna panel index.

In some embodiments, the CORESET group information includes a CORESET group ID, and a CORESET group index.

In some embodiments, the reference signal set information includes one or more reference signals. The reference signal includes a synchronization reference signal and/or a measurement reference signal. The synchronization reference signal is configured to achieve uplink synchronization between the terminal device and the network device. The measurement reference signal is configured to measure channel state information between the terminal device and the network device. The measurement reference signal includes at least one of an SRS, a phase tracking reference signal (PT-RS), a DMRS, or a CSI-RS. The contents included in the reference signal are not limited herein. The reference signal set information includes a reference signal set ID, a reference signal set index, a reference signal resource ID, or a reference signal resource index.

In some embodiments, in the case that the at least one uplink information includes the reference signal and the spatial information includes the reference signal set information, the reference signal included in the at least one uplink information is different from the reference signal included in the reference signal set information.

In some embodiments, the TCI state information includes or indicates one or more TCI states or one or more TCI state IDs.

In some embodiments, the beam information includes one or more transmit beams configured to transmit the uplink information and/or one or more receive beams for receiving the uplink information. In some embodiments, the transmit beam corresponds to a spatial domain transmit filter, and the receive beam corresponds to a spatial domain receive filter.

In some embodiments, the capability set information includes one or more parameters. For example, the capability set information is a capability set supported by the terminal device or reference signal information associated with the capability set supported by the terminal device. In some embodiments, the capability set information includes at least one of the following parameters: a channel bandwidth supported by the terminal device, the number of transmit antennas supported by the terminal device, the number of hybrid automatic repeat request (HARQ) processes supported by the terminal device, a maximum modulation method for uplink data transmission, a maximum modulation method for downlink data transmission, a PDSCH processing capability, a PUSCH processing capability, a power saving capability of the terminal device, a coverage enhancement capability of the terminal device, a data transmission rate enhancement capability of the terminal device, a short delay processing capability of the terminal device, a small data transmission capability of the terminal device, an inactive data transmission capability of the terminal device, a transmission reliability capability of the terminal device, a URLLC data transmission capability of the terminal device, or the like. The parameters included in the capability set information are not limited herein.

In some embodiments, the at least one resource configured to transmit the at least one uplink information includes at least one of at least one FDM resource, at least one SDM resource, at least one CDM resource, or at least one TDM resource.

In some embodiments, the same uplink information is transmitted on the FDM resource, the same uplink information is transmitted by the SDM resource, the same uplink information is transmitted by the CDM resource, or the same uplink information is transmitted by the TDM resource. For example, the PUCCH is transmitted by the FDM resource. As another example, a transmission layer corresponding to the PUCCH is transmitted by the CDM resource.

In some other embodiments, different uplink information is transmitted by the FDM resource, different uplink information is transmitted by the SDM resource, different uplink information is transmitted by the CDM resource, or different uplink information is transmitted by the TDM resource. For example, the resource configured to transmit the PUCCH and the resource configured to transmit the PUSCH are the FDM resources. As another example, the resource configured to transmit one transmission layer corresponding to the PUCCH and the resource configured to transmit another transmission layer corresponding to the PUCCH are the SDM resources.

For example, the at least one resource configured to transmit at least one uplink information includes a first resource and a second resource. The first resource and the second resource are at least one of the FDM resource, the SDM resource, the CDM resource, or the TDM resource.

In some embodiments, the at least one resource configured to transmit at least one uplink information includes a non-frequency hopping resource.

In some embodiments, each of the at least one resource is the non-frequency hopping resource. In some other embodiments, a portion of the at least one resource is the non-frequency hopping resource, and another portion of the at least one resource is a frequency hopping resource. The number of non-frequency hopping resources is higher or lower than or equal to the number of frequency hopping resources.

In some embodiments, the at least one resource includes a non-frequency hopping resource, which is predefined by the protocol, or is predefined by the terminal device, or is configured by the network device.

In some embodiments, in the case that a frequency hopping identifier in the DCI is 0 bit, or in the case that the frequency hopping identifier in the DCI is 1 bit and the state is ‘disable’, the at least one resource (e.g., including the first resource and the second resource) is the non-frequency hopping resource.

In some embodiments, the format of the DCI is format 0_0, format 0_1, or format 0_2.

In some embodiments, the at least one resource includes the first resource and the second resource.

The first resource belongs to a first resource set, and the second resource belongs to a second resource set.

The first resource set and/or the second resource set includes one or more resource block groups (RBGs), or, the first resource set and/or the second resource set includes one or more RBs.

In some embodiments, the first resource and/or the second resource is at least one RBG or at least one RB. In some embodiments, the one or more RBGs is at least one RBG on at least one time unit, or, the one or more RBs is at least one RB on at least one time unit. The time unit is a symbol, a time slot, a subframe, a time window, or the like.

In some embodiments, the first resource and the second resource are multiplexed resources. For example, the first resource and the second resource are multiplexed in at least one of: FDM, SDM, CDM, or TDM. In some embodiments, the first resource and the second resource are not any of: the FDM resource, the SDM resource, the CDM resource, or the TDM resource.

In some embodiments, the first resource set and/or the second resource set is a set of resources that are contiguous or non-contiguous in the frequency domain. In some embodiments, the first resource set and/or the second resource set is a set of resources that are contiguous or non-contiguous in the time domain.

In some embodiments, the first resource set and/or the second resource set is predefined by the protocol, is predefined by the terminal device, or is configured by the network device.

In some embodiments, the first resource set and the second resource set are not overlapped. For example, the first resource set and the second resource set are not overlapped both in the time domain and in the frequency domain.

In some embodiments, indexes of one or more RBGs included in the first resource set are different from indexes of one or more RBGs included in the second resource set.

In some embodiments, indexes of one or more RBs included in the first resource set are different from indexes of one or more RBs included in the second resource set.

In the case that the first resource set includes one or more RBGs and the second resource set includes one or more RBGs:
in some embodiments, the indexes of one or more RBGs included in the first resource set are smaller than the indexes of one or more RBGs included in the second resource set.

In some embodiments, the indexes of the one or more RBGs included in the first resource set are all smaller than the indexes of the one or more RBGs included in the second resource set.

In some embodiments, a difference between a minimum value of the indexes of one or more RBGs included in the second resource set and a maximum value of the indexes of one or more RBGs included in the first resource set is 1 or is an integer greater than or equal to 2.

In some embodiments, the first resource set is referred to as a first range RBG or a first range RBG group. In some other embodiments, the second resource set is referred to as a second range RBG or a second range RBG group.

FIG. 4 is a schematic diagram of a first resource set and a second resource set according to some embodiments of the present disclosure. As shown in FIG. 4, the first resource set includes └n/2┘ (the rounding up of n/2) RBGs. For example, the first resource set includes an RBG index 0, . . . , and an RBG index (└n/2┘−1)). The second resource set includes └n/2┘ (the rounding down of n/2) RBGs. For example, the second resource set includes: an RBG index (└n/2┘ . . . , and an RBG index n−1.

For example, in the case that n is even, └n/2┘ is (n/2)-1 and └n/2 ┐ is (n/2). A value of n is determined based on the number of RBs included in the uplink BWP. For example, the value of n is determined based on the number of RBs included in the BWP in conjunction with the number of RBs included in the RBG.

The first resource set is associated with the first spatial information, and the second resource set is associated with the second spatial information. Exemplarily, the first spatial information includes a first TRP (TRP 1), and/or a first panel (panel 1), and/or a first TCI state, and the second spatial information includes a second TRP (TRP 2), and/or a second panel (panel 2), and/or a second TCI state.

For example, in FIG. 4, the first resource set is associated with the first TRP (TRP 1) and/or the first panel (panel 1), and the second resource set is associated with the second TRP (TRP 2) and/or the second panel (panel 2).

In some embodiments, the indexes of one or more RBGs included in the first resource set are even numbers, and the indexes of one or more RBGs included in the second resource set are odd numbers.

For example, the index of the one or more RBGs included in the first resource set is 0, 2, 4, or the like. The index of the one or more RBGs included in the second resource set is 1, 3, 5, or the like.

FIG. 5 is a schematic diagram of another first resource set and second resource set according to some embodiments of the present disclosure. As shown in FIG. 5, the first resource set includes an RBG index 0, an RBG index 2, . . . , and an RBG index 2m−2. The second resource set includes an RBG index 1, an RBG index 3, . . . , and an RBG index 2m−1.

The first resource set is associated with the first spatial information, and the second resource set is associated with the second spatial information. Exemplarily, the first spatial information includes a first TRP (TRP 1), and/or a first panel (panel 1), and/or a first TCI state; and the second spatial information includes a second TRP (TRP 2), and/or a second panel (panel 2), and/or a second TCI state.

For example, in FIG. 5, the first resource set is associated with the first TRP (TRP 1) and/or the first panel (panel1), and the second resource set is associated with the second TRP (TRP 2) and/or the second panel (panel2).

In some embodiments, some of the indexes of the plurality of RBGs included in the first resource set and/or the second resource set are consecutive, and the number of contiguous RBGs is at least two.

FIG. 6 is a schematic diagram of yet another first resource set and second resource set according to some embodiments of the present disclosure. As shown in FIG. 6, the indexes of the RBGs included in the first resource set and the second resource set are partially consecutive, and the number of contiguous RBGs is p. p is a predefined value and is greater than or equal to 2. In the embodiments of FIG. 6, a value of p is 4. In this way, first four contiguous RBGs (RBG 0 to RBG 3) are included in the first resource set, second four contiguous RBGs (RBG 4 to RBG 7) are included in the second resource set, third four contiguous RBGs (RBG 8 to RBG 11) are included in the first resource set, and the like, until the last one or two or three or four RBGs are included in the first resource set or the second resource set.

The first resource set is associated with the first spatial information and the second resource set is associated with the second spatial information. Exemplarily, the first spatial information includes a first TRP (TRP 1), and/or a first panel (panel 1), and/or a first TCI state; and the second spatial information includes a second TRP (TRP 2), and/or a second panel (panel 2), and/or a second TCI state.

For example, in FIG. 6, the first resource set is associated with the first TRP (TRP 1) and/or the first panel (panel 1), and the second resource set is associated with the second TRP (TRP 2) and/or the second panel (panel 2)

In the case that the first resource set includes one or more RBs and the second resource set includes one or more RBs:
in some embodiments, indexes of one or more RBs included in the first resource set are smaller than indexes of one or more RBs included in the second resource set.

In some embodiments, the first resource set is referred to as a first resource block group, and the second resource set is referred to as a second resource block group.

FIG. 7 is a schematic diagram of yet another first resource set and second resource set according to some embodiments of the present disclosure. As shown in 7. The RB included in the first resource set is Ceil (LRB/2┘, wherein Ceil (LRB/2┘ is a rounding up of (LRB/2┘. The RB included in the second resource set is LRB-Ceil (LRB/2┘, wherein the LRB is the total number of RBs allocated to the terminal device. For example, the LRB is the total number of RBs allocated by the network device to the terminal device. As another example, the LRB is the total number of RBs on one or more time units allocated to the terminal device.

The first resource set is associated with first spatial information and the second resource set is associated with second spatial information. Exemplarily, the first spatial information includes a first TRP (TRP 1), and/or a first panel (panel 1), and/or a first TCI state; and the second spatial information includes a second TRP (TRP 2), and/or a second panel (panel 2), and/or a second TCI state.

For example, in FIG. 7, the first resource set is associated with the first TRP (TRP 1) and/or the first panel (panel 1), and the second resource set is associated with the second TRP (TRP 2) and/or the second panel (panel 2).

In some embodiments, the indexes of one or more RBs included in the first resource set are all smaller than the indexes of one or more RBs included in the second resource set.

In some embodiments, a difference between a minimum value of the indexes of one or more RBs included in the second resource set and a maximum value of the indexes of one or more RBs included in the first resource set is 1 or an integer greater than or equal to 2.

In some embodiments, the indexes of one or more RBs included in the first resource set are even numbers and the indexes of one or more RBs included in the second resource set are odd numbers.

For example, the first resource set includes one or more RBs with the indexes of 0, 2, 4, and the like. and the second resource set includes one or more RBs with the indexes of 1, 3, 5, and the like.

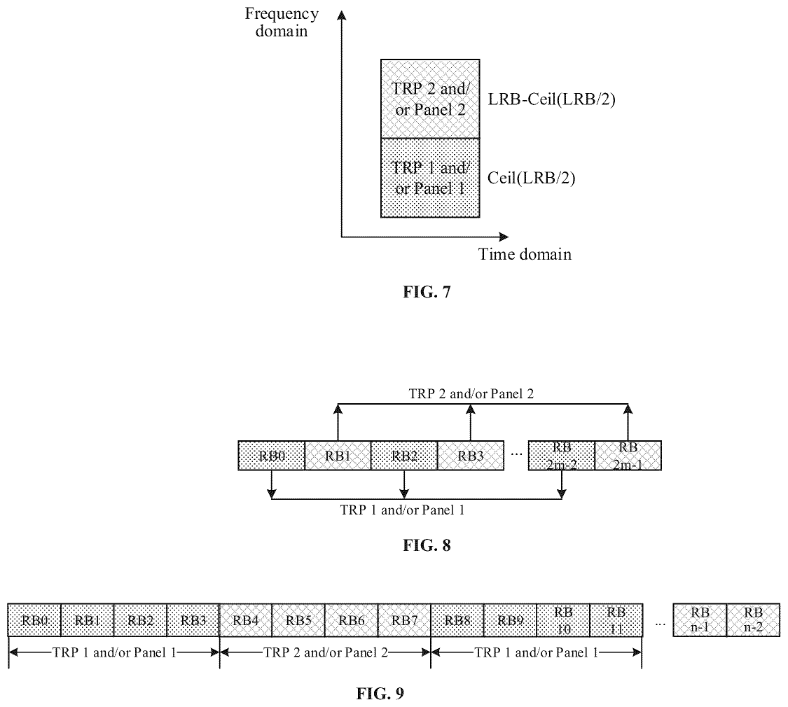

FIG. 8 is a schematic diagram of a first resource set and a second resource set according to some other embodiments of the present disclosure. As shown in FIG. 8, the first resource set includes an RB index 0, an RB index 2, . . . , and an RB index 2m−2, and the second resource set includes an RB index 1, an RB index 3, . . . , and an RB index 2m−1.

The first resource set is associated with the first spatial information and the second resource set is associated with the second spatial information. Exemplarily, the first spatial information includes a first TRP (TRP 1), and/or a first panel (panel 1), and/or a first TCI state; and the second spatial information includes a second TRP (TRP 2), and/or a second panel (panel 2), and/or a second TCI state.

For example, in FIG. 8, the first resource set is associated with the first TRP (TRP 1) and/or the first panel (panel 1), and the second resource set is associated with the second TRP (TRP 2) and/or the second panel (panel 2).

In some embodiments, indexes of a plurality of RBs included in the first resource set and/or the second resource set are partially consecutive, and the number of contiguous RBs is at least two.

FIG. 9 is a schematic diagram of a first resource set and a second resource set according to some other embodiments of the present disclosure. As shown in FIG. 9, the indexes of the RBs included in the first resource set and the second resource set are partially consecutive, and the number of contiguous RBs is q. q is a predefined value and is greater than or equal to 2. In the embodiments of FIG. 9, the value of p is 4. In this way, first four contiguous RBs (RB 0 to RB 3) are included in the first resource set, second four contiguous RBs (RB 4 to RB 7) are included in the second resource set, and third four contiguous RBs (RB 8 to RB 11) are included in the first resource set, until a final one or two or three or four RBs are included in the first resource set or the second resource set.

The first resource set is associated with the first spatial information and the second resource set is associated with the second spatial information. Exemplarily, the first spatial information includes a first TRP (TRP 1), and/or a first panel (panel1), and/or a first TCI state; and the second spatial information includes a second TRP (TRP 2), and/or a second panel (panel 2), and/or a second TCI state.

For example, in FIG. 9, the first resource set is associated with the first TRP (TRP 1) and/or the first panel (panel 1), and the second resource set is associated with the second TRP (TRP 2) and/or the second panel (panel 2).

It should be noted that while both the first spatial information and the second spatial information exemplified in FIG. 4 to FIG. 9 include TRPs and/or panels, however, some embodiments of the present disclosure are not limited thereto. In some other embodiments, the first spatial information and/or the second spatial information include other content. For example, the first spatial information and the second spatial information include CORESET group information, such that the first resource set is associated with first CORESET group information and the second resource set is associated with second CORESET group information. The embodiments of the present disclosure do not limit the content associated with the first resource set and/or the second resource set. Exemplarily, the first resource set is associated with at least one of: first antenna panel information, first TRP information, first CORESET group information, first reference signal set information, first TCI state information, first beam information, or first capability set information; and the second resource set is associated with at least one of: second antenna panel information, second TRP information, second CORESET group information, second reference signal set information, second transmission TCI state information, second beam information, or second capability set information.

It should be noted that the illustration of the first resource set and the second resource set in the case that the first resource set includes one or more RBs and the second resource set includes one or more RBs, is cross-referenced to the illustration of the first resource set and the second resource set in the case that the first resource set includes one or more RBGs and the second resource set includes one or more RBGs, which are not further described herein.

In some embodiments, in the case that the first resource set includes one or more RBGs and the second resource set includes one or more RBGs, the resource allocation type of the first resource and the second resource is resource allocation type 0 (uplink resource allocation type 0). In the case that the first resource set includes one or more RBs and the second resource set includes one or more RBs, the resource allocation type of the first resource and the second resource is resource allocation type 1 (uplink resource allocation type 1).

In some embodiments, the first resource set is associated with the first spatial information and the second resource set is associated with the second spatial information.

In some embodiments, at least one of the total number of resources, a starting resource, or an ending resource in the first resource set is indicated by a frequency domain resource allocation field in the DCI.

In some embodiments, the first resource is determined based on the first resource set and a first bitmap, and/or, the second resource is determined based on the second resource set and a second bitmap.

In some embodiments, the first bitmap and/or the second bitmap are predefined by the protocol, predefined by the terminal device, or configured by the network device.

In some embodiments, the RBGs included in the first resource are in one-to-one correspondence with the RBGs in the first resource set by a bitmap, and the RBGs included in the second resource are in one-to-one correspondence with the RBGs in the second resource set by a bitmap. For example, in the case that a bit is 1, an RBG corresponding to the bit belongs to the first resource or the second resource, and in the case that a bit is 0, an RBG corresponding to the bit does not belong to the first resource or the second resource.

In the case that the first resource set includes one or more RBs and the second resource set includes one or more RBs (i.e., in the case of the first resource set and the second resource set with RB as the granularity):
in some embodiments, a location of a starting RB of the first resource set and/or the second resource set is a location of the first RB of the BWP.

In yet other embodiments, the location of the starting RB of the first resource set and/or the second resource set is a location of common resource block (CRB) 0.

In still yet other embodiments, the location of the starting RB of the first resource set and/or the second resource set is a location of Point A. In some embodiments, a center of subcarrier 0 of CRB 0 is Point A.

In some embodiments, the location is a center frequency point, a start frequency location, or an end frequency location. Alternatively, the location of the resource block involved in the present disclosure refers to the center frequency point of the resource block, the start frequency location of the resource block, or the end frequency location of the resource block.

In some embodiments, in the case that a waveform of the at least one uplink information is discrete Fourier transform-spreading-orthogonal frequency division multiplexing (DFT-S-OFDM), the RBGs or RBs included in each of the at least one resource are contiguous, or the RBGs or RBs included in each of the at least one resource are non-contiguous.

In some embodiments, the contiguous/non-contiguous RBGs included in each resource indicate that the indexes of the RBGs included in each resource are consecutive/non-consecutive. The contiguous/non-contiguous RBs included in each resource indicate that the indexes of the RBs included in each resource are consecutive/non-consecutive.

In some embodiments, in the case that the waveform of the at least one uplink information is cyclic prefix-orthogonal frequency division multiplexing (CP-OFDM), the RBGs or RBs included in each of the at least one resource are contiguous. Alternatively, the RBGs or RBs included in each of the at least one resource are almost contiguous (almost contiguous allocation).

The RBGs or RBs included in each resource being almost contiguous includes the following cases: there are S intermittent portions of RBGs or RBs included in each resource, wherein S is less than a first threshold; or there are S intermittent portions of RBGs or RBs included in each resource, wherein a ratio of S to the number of RBGs or RBs included in each resource is less than a second threshold; or the intermittent portions present in the RBGs or RBs included in each resource correspond to R RBGs or RBs, wherein R is less than a third threshold; or the intermittent portions present in the RBGs or RBs included in each resource correspond to R RBGs or RBs, wherein a ratio of R to the number of RBGs or RBs included in each resource is less than a fourth threshold. It should be understood that almost contiguous allocation has other interpretations, which are not enumerated in the embodiments of the present disclosure. In some embodiments, at least one of the first to fourth thresholds is predefined by the protocol, is predefined by the terminal device, or is configured by the network device.

In this way, for the waveform of DFT-S-OFDM, the first resource and the second resource include contiguous or non-contiguous RBGs, and for the waveform of CP-OFDM, the first resource and the second resource include contiguous or almost-contiguous RBGs.

Some embodiments of the present disclosure give a FDM resource division method with RBG as the granularity in the non-frequency hopping case, and the division method is simple. Some embodiments of the present disclosure also give a FDM resource division method with RB as the granularity in the non-frequency hopping case, which is more flexible in resource allocation relative to using RBG as the granularity.

In some embodiments, the at least one resource includes a frequency hopping resource.

In some embodiments, each of the at least one resource is a frequency hopping resource. That is, each of the at least one resource is a resource that is transmitted in a frequency hopping manner. In some other embodiments, a portion of the at least one resource is a non-frequency hopping resource and another portion of the resource is a frequency hopping resource.

In some embodiments, the at least one resource includes the frequency hopping resource, which is predefined by the protocol, predefined by the terminal device, or configured by the network device.

In some embodiments, in the case that a frequency hopping identifier in the DCI is 1 bit or the frequency hopping identifier in the DCI is 1 bit and the state is ‘enable’, the at least one resource (e.g., including the first resource and the second resource) is the frequency hopping resource. Different resources are associated with different spatial information. For example, the at least one resource includes the first resource and the second resource, wherein the first resource is associated with the first spatial information and the second resource is associated with the second spatial information.

In some embodiments, a format of the DCI is format 0_0, format 0_1, or format 0_2.

In some embodiments, the at least one resource includes the first resource and the second resource. The first resource includes a first frequency hopping resource and a second frequency hopping resource, and the second resource includes a third frequency hopping resource and a fourth frequency hopping resource.

In some embodiments, a starting RB index of the third frequency hopping resource is the sum of a starting RB index of the first frequency hopping resource and the number of RBs in the first frequency hopping resource; and
a starting RB index of the fourth frequency hopping resource is the sum of a starting RB index of the second frequency hopping resource and the number of RBs in the second frequency hopping resource.

In some embodiments, the spatial information associated with the first resource is different from the spatial information associated with the second resource.

The spatial information includes at least one of: panel information, CORESET group information, reference signal set information, TCI state information, beam information, or capability set information.

For example, the first frequency hopping resource and the second frequency hopping resource are associated with first spatial information, and the third frequency hopping resource and the fourth frequency hopping resource are associated with second spatial information.

In some embodiments, the number of RBs of the first frequency hopping resource and/or the number of RBs of the second frequency hopping resource is ┌LRB/2┐ (a rounding up of LRB/2), the number of RBs of the third frequency hopping resource and/or the number of RBs of the fourth frequency hopping resource is ┌LRB/2┐ (a rounding down of LRB/2), or is a result of LRB minus the number of RBs in the first frequency hopping resource or the second frequency hopping resource.

L_{RB} is the total number of RBs allocated to the terminal device.

For example, in the case that LRB is even, the number of RBs of the first frequency hopping resource and/or the number of RBs of the second frequency hopping resource, and the number of RBs of the third frequency hopping resource and/or the number of RBs of the fourth frequency hopping resource are (LRB/2). In the case that LRB is odd, for example, LRB is 5, the number of RBs of the first frequency hopping resource and/or the number of RBs of the second frequency hopping resource is ┌5/2┐, i.e., 3, and the number of RBs of the third frequency hopping resource and/or the number of RBs of the fourth frequency hopping resource is 2.

In some other embodiments, the number of RBs of the first frequency hopping resource and/or the number of RBs of the second frequency hopping resource is ┌L_{RB}/2┐, and the number of RBs of the third frequency hopping resource and/or the number of RBs of the fourth frequency hopping resource is ┌L_{RB}/2┘, or is a result of L_{RB} minus the number of RBs of the first frequency hopping resource or the second frequency hopping resource.

For example, in the case that L_{RB} is even, for example, L_{RB} is 5, the number of RBs of the first frequency hopping resource and/or the number of RBs of the second frequency hopping resource ┌5/2┘, i.e., 2, and the number of RBs of the third frequency hopping resource and/or the number of RBs of the fourth frequency hopping resource is 3.

In some embodiments, a starting RB index of the first frequency hopping resource is RBₛₜₐᵣₜ.

A starting RB index of the second frequency hopping resource is (RBₛₜₐᵣₜ+RB_{offset})modN_{BWP}^{size}. RB_{offset} represents a frequency offset in RBs between frequency hops, and the N_{BWP}^{size} is the number of RBs of the uplink activated BWP.

A starting RB index of the third frequency hopping resource is RBₛₜₐᵣₜ+┌L_{RB}/2┘ or RBₛₜₐᵣₜ+└L_{RB}/2┘. L_{RB} is the total number of RBs allocated to the terminal device.

A starting RB index of the fourth frequency hopping resource is (RBₛₜₐᵣₜ+RB_{offset})modN_{BWP}^{size}+┌L_{RB}/2┘ or (RBₛₜₐᵣₜ+RB_{offset})modN_{BWP}^{size}+└L_{RB}/2┘.

AmodB represents a remainder of A divided by B.

In some embodiments, at least one of RBₛₜₐᵣₜ, RB_{offset}, and N_{BWP}^{size} is predefined in the protocol, or predefined by the terminal device, or configured by the network device.

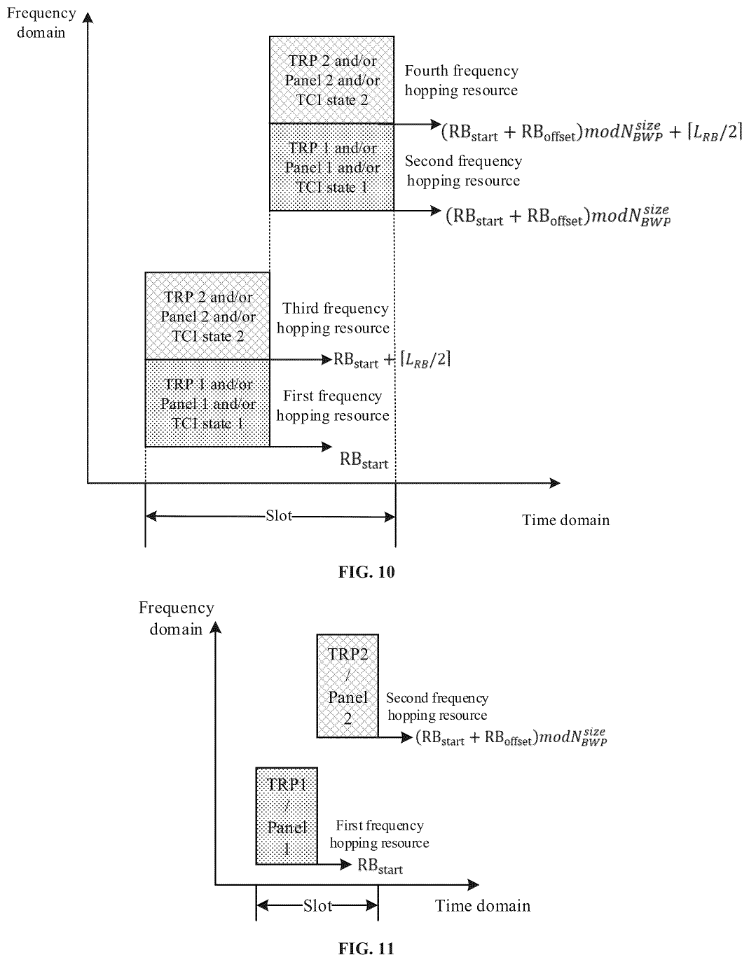

FIG. 10 is a schematic diagram of a starting RB location of a first frequency hopping resource to a fourth frequency hopping resource according to some embodiments of the present disclosure. As shown in FIG. 10, the starting RB index of the first frequency hopping resource is RBₛₜₐᵣₜ, the starting RB index of the third frequency hopping resource is RBₛₜₐᵣₜ+┌L_{RB}/2┘, the starting RB index of the second frequency hopping resource is (RBₛₜₐᵣₜ+RB_{offset})modN_{BWP}^{size}, and the starting RB index of the fourth frequency hopping resource is (RBₛₜₐᵣₜ+RB_{offset})modN_{BWP}^{size}+┌L_{RB}/2.

The first frequency hopping resource and the second frequency hopping resource are associated with the first spatial information, and the third frequency hopping resource and the fourth frequency hopping resource are associated with the second spatial information. Exemplarily, the first spatial information includes a first TRP (TRP 1), and/or a first panel (panel 1), and/or a first TCI state; and the second spatial information includes a second TRP (TRP 2), and/or a second panel (panel 2), and/or a second TCI state.

For example, in FIG. 10, the first frequency hopping resource and the second frequency hopping resource are associated with the first TRP (TRP 1), and/or the first panel (panel 1), and/or the first TCI state (TCI state 1). The third frequency hopping resource and the fourth frequency hopping resource are associated with the second TRP (TRP 2), and/or the second panel (panel 2), and/or the second TCI state (TCI state 2).

In some embodiments, the first frequency hopping resource and the third frequency hopping resource are overlapped in the time domain, and the second frequency hopping resource and the fourth frequency hopping resource are overlapped in the time domain. In some embodiments, the first frequency hopping resource and the third frequency hopping resource occupy the same time domain resource, and the third frequency hopping resource and the fourth frequency hopping resource occupy the same time domain resource.

In some embodiments, the first frequency hopping resource is not overlapped with the second and/or fourth frequency hopping resource in the time domain. That is, a time domain resource occupied by the first frequency hopping resource is different from a time domain resource occupied by the second and/or fourth frequency hopping resource. The third frequency hopping resource is not overlapped with the second and/or fourth frequency hopping resource in the time domain. That is, a time domain resource occupied by the third frequency hopping resource is different from a time domain resource occupied by the second and/or fourth frequency hopping resource.

For example, in a time slot, the first frequency hopping resource and the third frequency hopping resource occupy resources in the first half of the time slot, and the second frequency hopping resource and the fourth frequency hopping resource occupy resources in the second half of the time slot.

In some embodiments, an end symbol of the first frequency hopping resource and/or the third frequency hopping resource is an adjacent symbol to a start symbol of the second frequency hopping resource and/or the fourth frequency hopping resource, or spaced at least one symbol apart from the start symbol of the second frequency hopping resource and/or the fourth frequency hopping resource.

In some embodiments of the present disclosure, the FDM resource division method with RB as a granularity is applicable to the case where the at least one resource includes a frequency hopping resource, and the locations of the third frequency hopping resource and the fourth frequency hopping resource are defined according to a specific frequency domain offset based on the relevant protocol.

In some embodiments, the starting RB index of the first frequency hopping resource is RBₛₜₐᵣₜ.

The starting RB index of the second frequency hopping resource is (RBₛₜₐᵣₜ+RB_{offset})modN_{BWP}^{size}. RB_{offset} is the frequency offset in RBs between frequency hops, and the N_{BWP}^{size} is the number of RBs in the uplink activated BWP.

The starting RB index of the third frequency hopping resource is RBₛₜₐᵣₜ+RB_{offset1}. The RB_{offset1} is predefined, indicated by the DCI, or indicated by a radio resource control (RRC).

The starting RB index of the fourth frequency hopping resource is (RBₛₜₐᵣₜ+RB_{offset+RB}_{offset1})modN_{BWP}^{size}.

In some embodiments of the present disclosure, RB_{offset1} is used instead of a specific frequency domain offset, such that the frequency domain locations of the third frequency hopping resource and the fourth frequency hopping resource are more flexible.

In some embodiments, one resource of the first frequency hopping resource and the third frequency hopping resource includes contiguous RB resources and the other resource is an interlace resource.

In some embodiments, one resource of the second frequency hopping resource and the fourth frequency hopping resource includes contiguous RB resources and the other resource is an interlace resource.

For example, the first frequency hopping resource includes contiguous RB resources and the third frequency hopping resource is an interlace resource, or the first frequency hopping resource is an interlace resource and the third frequency hopping resource includes contiguous RB resources.

For example, the second frequency hopping resource includes contiguous RB resources and the fourth frequency hopping resource is an interlace resource, or the second frequency hopping resource is an interlace resource and the fourth frequency hopping resource includes contiguous RB resources.

In some embodiments, the at least one resource includes the first resource and the second resource.

In some embodiments, the number of RBs of the first resource and/or the number of RBs of the second resource is L_{RB}. L_{RB} is the total number of RBs allocated to the terminal device.

In some embodiments, the starting RB index of the first resource is RBₛₜₐᵣₜ and the starting RB index of the second resource is (RBₛₜₐᵣₜ+RB_{offset})modN_{BWP}^{size}. RB_{offset} is the frequency offset in RBs between frequency hops, and the N_{BWP}^{size} is the number of RBs of uplink activated BWP.

FIG. 11 is a schematic diagram of starting RB locations of a first resource and a second resource according to some embodiments of the present disclosure. As shown in FIG. 11, the starting RB index of the first resource is RBₛₜₐᵣₜ, and the starting RB index of the second resource is (RBₛₜₐᵣₜ+RB_{offset})modN_{BWP}^{size}.

The first resource is associated with a first TRP (TRP 1), and/or a first panel (panel 1), and/or a first TCI state. The second resource is associated with a second TRP (TRP 2), and/or a second panel (panel 2), and/or a second TCI state.

The first resource and the second resource are TDM resources, or the first resource and the second resource are not overlapped in the time domain.

In some embodiments of the present disclosure, the first resource and the second resource respectively occupy two-hop resources defined in the relevant protocols, which has little impact on the protocols and is simple to implement.

In some embodiments, the following description is given to illustrate the case where the at least one resource includes a non-hopping resource and/or a hopping resource.

The resource allocation type of the first resource and the second resource is resource allocation type 2 (uplink resource allocation type 2).

In some embodiments, at least a portion of the at least one resource is an interlace resource. For example, the at least one resource includes a first resource and a second resource, the first resource and the second resource are the interlace resources. As another example, the at least one resource includes a first resource and a second resource, the first resource is the interlace resource, and the second resource is a non-interlace resource.

In some embodiments, a portion of the at least one resource is an interlace resource, and another portion of the at least one resource is a non-interlace resource. In some embodiments, each of the at least one resource is the interlace resource.

In some embodiments, the at least the portion of the at least one resource is the interlace resource, and/or the interlace configuration information of the at least the portion of the at least one resource is configured by protocol predefined information, pre-configuration information, or network configuration information.

In some embodiments, the network device configures a first parameter useInterlacePUCCH-PUSCH to the terminal device, and the terminal device determines the at least one resource to be the interlace resource based on the first parameter useInterlacePUCCH-PUSCH.

For example, in the case that the first resource and the second resource are the interlace resources, the network device configures the first parameter useInterlacePUCCH-PUSCH to the terminal device, and the terminal device determines that the first resource and the second resource are the interlace resources.

In some embodiments, the interlace configuration information of at least the portion of the at least one resource includes interlace configuration information of each of the at least the portion of the at least one resource. In some embodiments, the interlace configuration information of different resources is the same or different.

In some embodiments, the interlace configuration information of the at least the portion of the at least one resource is related to a subcarrier spacing (SCS) and/or a granularity of the interlace. The granularity of the interlace is the number of RBs included in one interlace.

In some embodiments, the interlace configuration information includes the granularity of the interlaces and/or the number of interlaces. Description is given in some embodiments of the present disclosure using a scenario where the interlace configuration information includes the number of interlaces as an example.

Table 1 is a schematic diagram of interlace configuration information according to some embodiments of the present disclosure.

TABLE 1

| μ | M |
|---|---|
| 0 | n1 |
| 1 | n2 |
| 2 | n3 |
| 3 | n4 |

In Table 1, M is the granularity of the interlace. That is, one interlace includes M RBs. The granularity of the interlace is predefined by the protocol, is predefined by the terminal device, or is configured by the network device. n1, n2, n3, and n4 are the number of interlaces. n1, n2, n3, and n4 are different. For example, n1>n2>n3>n4. As another example, n1>n2>n3>n4, and n1, n2, n3, and n4 are all integers multiple of 2. Different subcarrier spacings correspond to different numbers of interlaces.

Table 2 is a schematic diagram of another interlace configuration information according to some embodiments of the present disclosure.

TABLE 2

| μ | M1 | M2 | M3 | M4 |
|---|---|---|---|---|
| 0 | n11 | n12 | n13 | n14 |
| 1 | n21 | n22 | n23 | n24 |
| 2 | n31 | n32 | n33 | n34 |
| 3 | n41 | n42 | n43 | n44 |

In Table 2, n11, n12, and the like are the number of interlaces, and the number of interlaces is related to the subcarrier spacing μ, and is also related to the granularity of the configured interlace (e.g., M1, M2, M3, or M4). For the same subcarrier spacing, the granularity of the interlace has multiple configurations. The network device indicates terminal device that the value of M is M1, M2, M3, or M4.

In some embodiments, the at least one resource includes K resources, and the K resources occupy contiguous M×N RBs in the frequency domain.

Each of the K resources includes N sub-resources. RB locations of adjacent two sub-resources in the each of the K resources are spaced apart from each other by M RBs, and the K contiguous sub-resources in the frequency domain occupy M RBs. K and N are integers greater than or equal to 2, and M is an integer multiple of the K. The location of the RB is a center frequency point, a start frequency location, or an end frequency location of the RB.

In some embodiments, the K contiguous sub-resources in the frequency domain each belong to K resources. For example, in the case that K is 2, the K resources include a first resource and a second resource, and two contiguous sub-resources belong to the first resource and the second resource, respectively, or belong to the second resource and the first resource, respectively.

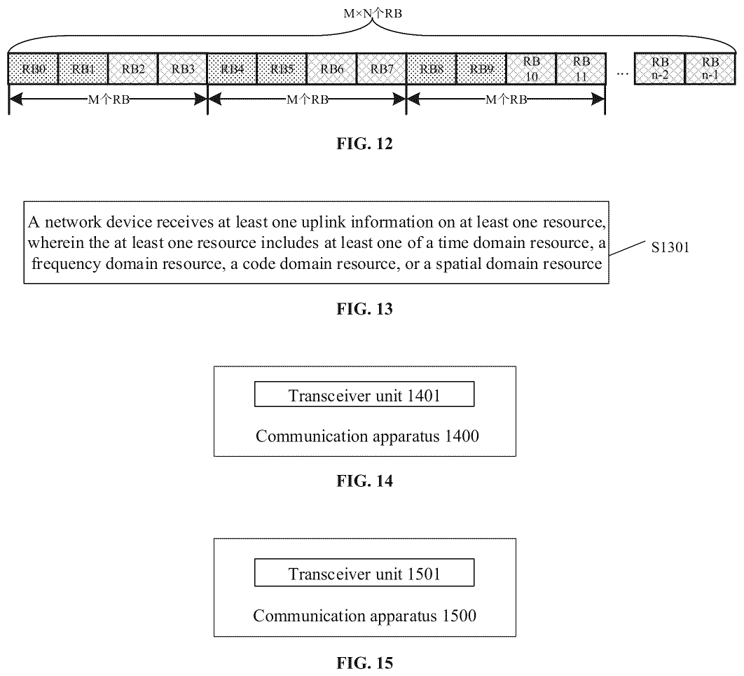

FIG. 12 is a schematic diagram of a resource distribution according to some embodiments of the present disclosure. As shown in FIG. 12, K is equal to 2 and the K resources include the first resource and the second resource. The first resource occupies the first half of the RBs in every M RBs, and the second resource occupies the second half of the RBs in every M RBs. For example, in FIG. 12, M is 4, RB 0 and RB 1 belong to the first resource, RB 2 and RB 3 belong to the second resource, RB4 and RB5 belong to the first resource, RB 6 and RB 7 belong to the second resource, and the like, until the last 2 RBs (RB n−2 and RB n−1) belong to the first resource or the second resource. RB0 represents RB index 0, RB1 represents RB index 1, and the like, which are not listed herein. In FIG. 12, one sub-resource occupies two contiguous RBs, or one sub-resource occupies two RBs whose indexes are consecutive. In some other embodiments, one sub-resource also occupies other numbers of contiguous RBs. For example, one sub-resource also occupies one contiguous RB, three contiguous RBs, four contiguous RBs, or the like, which are not limited herein.

In some embodiments, the at least one resource includes K resources, and the K resources are distributed on M×N contiguous RBs.

In some embodiments, the number of RBs corresponding to the K resources is less than M×N, such that the K resources occupy partial RBs of the M×N RBs. In some embodiments, the K resources are distributed uniformly or non-uniformly on the contiguous M×N RBs.

In some other embodiments, the number of RBs corresponding to the K resources is equal to M×N, such that the K resources occupy all of the M×N RBs.

Each resource of the K resources includes N candidate sub-resources. RB locations of adjacent two candidate sub-resources in each resource are spaced apart from each other by M RBs. The K candidate sub-resources that are contiguous in the frequency domain occupy M RBs. K and N are integers greater than or equal to 2, and M is an integer multiple of K.

In some embodiments, the K candidate sub-resources that are contiguous in the frequency domain each belong to K resources. For example, in the case that K is 2, the K resources include a first resource and a second resource, and the two contiguous candidate sub-resources each belong to the first resource and the second resource, or each belongs to the second resource and the first resource, or the two contiguous candidate sub-resources belong to the first resource only, or the two contiguous candidate sub-resources belong to the second resource only.

The network device is indicative of K resources to the terminal device. That is, each of the K resources includes t sub-resources, which belong to the N candidate sub-resources. For example, the network device indicates the t sub-resources included in the each of the K resources by physical layer signaling or higher layer signaling. For example, the network device indicates the t sub-resources for the each of the K resources by a bitmap, wherein the number of bits of the bitmap is N, and t bits have the state of 1. The RBs included in the corresponding sub-resources is configured for resource allocation.

In some embodiments, the first resource is referred to as an RB associated with an index 0. In some other embodiments, the second resource is referred to as an RB associated with an index 1.

In some embodiments of the present disclosure, greater frequency domain diversity gain is acquired by multiplexing the interlace resource allocation scheme.

In some embodiments, the at least one uplink information is associated with at least one of: a codeword, the number of transmission layers, an RV, a DMRS port, a DMRS port group, a PT-RS, or a DMRS.

The terminal device determines the at least one uplink information based on at least one of the codeword, the number of transmission layers, the RV, the DMRS port, the DMRS port group, the PT-RS, or the DMRS.

In some embodiments, different uplink information in the at least one uplink information is associated with the same codeword; or
different uplink information in the at least one uplink information is associated with different codewords; or
one portion of the uplink information in the at least one uplink information is associated with the same codeword and different uplink information in another portion of the uplink information is associated with different codewords.

In some embodiments, the at least one uplink information includes first uplink information and second uplink information. For example, both the first uplink information and the second uplink information are associated with a codeword 0. Alternatively, the first uplink information is associated with the codeword 0 and the second uplink information is associated with a codeword 1.

In some embodiments, the same number of transmission layers are employed for different uplink information in the at least one uplink information; or
different numbers of transmission layers are employed for different uplink information in the at least one uplink information; or
the same number of transmission layers are employed for one portion of the uplink information in the at least one uplink information, and different numbers of transmission layers are employed for different uplink information in another portion of the uplink information.

For example, the first uplink information and the second uplink information have the same number of transmission layers. Exemplarily, the number of transmission layers for both the first uplink information and the second uplink information is q, wherein q is greater than or equal to 1 and less than or equal to the total number of transmission layers that the terminal device supports. For example, q is 1, 2, 3, 4, 6, 8, or the like. Alternatively, q is ½ of the total number of transmission layers supported by the terminal device.

As another example, the number of transmission layers for the first uplink information is t, and the number of transmission layers for the second uplink information is s. t is different from s, and the sum of t and s is less than or equal to the total number of transmission layers supported by the terminal device.

For example, the number of transmission layers for the first uplink information is 1, and the number of transmission layers for the second uplink information is 2. As another example, the number of transmission layers for the first uplink information is 2, and the number of transmission layers for the second uplink information is 1.

In some embodiments, the at least one uplink information is associated with a first codeword, and the first codeword maps all transmission layers for the at least one uplink information.

In some embodiments, the at least one uplink information includes first uplink information and second uplink information.

The first uplink information is associated with a second codeword, and the second codeword maps the transmission layers for the first uplink information.

The second uplink information is associated with a third codeword, and the third codeword maps the transmission layers for the second uplink information.

For example, the first uplink information and the second uplink information are associated with two codewords, wherein one of the codewords maps to a first transmission layer (the transmission layer for the first uplink information) and the other codeword maps to a second transmission layer (the transmission layer for the second uplink information). The number of layers of the first transmission layer and the second transmission layer are both q, or the number of layers of the first transmission layer and the second transmission layer are t and s.

In some embodiments, the number of transmission layers for the at least one uplink information is indicated by first information; or
the number of transmission layers for one portion of the at least one uplink information is indicated by the first information, and the number of transmission layers for another portion of the at least one uplink information is determined in accordance with a predefined rule; or
the number of transmission layers for one portion of the at least one uplink information is indicated by the first information, and the number of transmission layers for another portion of the uplink information is indicated by second information.

The first information and/or the second information is RRC signaling or DCI. Alternatively, the first information and the second information are different fields in RRC signaling or different fields in DCI.

In some embodiments, the information of the number of transmission layers for the first uplink information and/or the second uplink information is indicated by the first information.

In other embodiments, the information of the number of transmission layers for the first uplink information is indicated by the first information, and the information of the number of transmission layers for the second uplink information is determined in accordance with a predefined rule. For example, the predefined rule indicates that the number of transmission layers for the second uplink information is 1, or the number of transmission layers for the second uplink information is the same as the number of transmission layers for the first uplink information.

In yet other embodiments, the information of the number of transmission layers for the first uplink information is indicated by the first information, and the information of the number of transmission layers for the second uplink information is indicated by the second information.

In some embodiments, the first information and the second information are RRC signaling, DCI, different fields in RRC signaling, or different fields in DCI. For example, the DCI format is format 0_1, format 0_2, or a new format. For example, the first information is indicated by the terminal device by a field of precoding information and the number of layers in the DCI, or a sounding reference signal (SRS) resource indicator (SRI). The second information is indicated by the field of precoding information and the number of layers in the DCI, or the SRI field.

In this way, transmission links corresponding to different spatial information have different qualities, and thus the use of different numbers of transmission layers facilitates the transmission of the information.

In some embodiments, the at least one uplink information is in one-to-one association with at least one DMRS port group; or
the at least one uplink information is in many-to-one association with at least one DMRS port group.

In some embodiments, the at least one uplink information includes p uplink information, wherein p is greater than or equal to 1.

In some embodiments, the p uplink information is in one-to-one correspondence with the p DMRS port groups. For example, first uplink information of the p uplink information corresponds to a first DMRS port group of the p DMRS port groups, and p^{th} uplink information of the p uplink information corresponds to a p^{th} DMRS port group of the p DMRS port groups. For example, the first uplink information is associated with the first DMRS port group, and the second uplink information is associated with the second DMRS port group.

In some embodiments, the p uplink information corresponds to j DMRS port groups. For example, the first

$$⌊ \frac{p}{j} ⌋$$

uplink information in the p uplink information corresponds to a first DMRS port group of the j DMRS port groups, and the like, and a last mod(p, j) (the operation of taking a remainder) in the p uplink information corresponds to a j^{th} DMRS port group of the j DMRS port groups. For example, p=4 and j=2, the first two uplink information corresponds to the first DMRS port group, and the last two uplink information corresponds to the second DMRS port group.

In some embodiments (p=2, j=2), the first transmission layer is associated with one DMRS port group of two DMRS port groups, and the second transmission layer is associated with another DMRS port group of the two DMRS port groups.

DMRS port group information associated with different uplink information in the at least one uplink information is indicated by different indication information, or the DMRS port group information associated with different uplink information in the at least one uplink information is indicated by different fields of the same indication information, or the DMRS port group information associated with the at least one uplink information is indicated by the same field of the same indication information.

In some embodiments, the at least one uplink information includes first uplink information and second uplink information.

A transmission layer for the first uplink information is associated with a first DMRS port group, and a transmission layer for the second uplink information is associated with a second DMRS port group.

In some embodiments, the DMRS port group associated with the at least one uplink information is indicated by different indication information, or by different fields of the same indication information, or by the same field of the same indication information.

In some embodiments, different uplink information in the at least one uplink information is associated with different DMRS ports in the same DMRS port group.

In some embodiments, the at least one uplink information includes first uplink information and second uplink information.

A transmission layer for the first uplink information is associated with a first DMRS port set in the at least one DMRS port group.

A transmission layer for the second uplink information is associated with a second DMRS port set in the at least one DMRS port group.

The number of DMRS ports included in the first DMRS port set is the same as the number of transmission layers for the first uplink information, and the number of DMRS ports included in the second DMRS port set is the same as the number of transmission layers for the second uplink information.

In some embodiments, the at least one DMRS port group is associated with one or more TCI states or has one or more QCL assumptions.

In some implementations, a first transmission layer is mapped to the first DMRS port set in one DMRS port group, and a second transmission layer is mapped to a second DMRS port set in one DMRS port group. The number of DMRS ports included in the first DMRS port set is the same as the number of layers of the first transmission layer, and the number of DMRS ports included in the second DMRS port set is the same as the number of layers of the second transmission layer.

In some embodiments, the at least one DMRS port group is associated with different TCI states, or has different QCL assumptions.

In some embodiments, that the at least one DMRS port group is associated with different TCI states comprises: each of the at least one DMRS port group is associated with different TCI states, for example, a certain DMRS port group is associated with a first TCI state and a second TCI state, or, different DMRS port groups in the at least one DMRS port group are associated with different TCI states, for example, the at least one DMRS port group includes a first DMRS port group and a second DMRS port group, the first DMRS port group is associated with a first TCI state and the second DMRS port group is associated with a second TCI state.

In some embodiments, the QCL assumption is associated with QCL information, or the QCL assumption is the QCL information. The QCL information includes a QCL type configuration and/or a QCL reference signal configuration.

For example, the QCL assumption is understood as the QCL information or is understood as any one or more of the information included in the QCL information. For example, different QCL assumptions include different QCL type configurations, different QCL reference signal configurations, or both different QCL type configurations and different QCL reference signal configurations. For the QCL type configuration and/or the QCL reference signal configuration, reference is made to the above explanation, which is not repeated herein.

In some embodiments, the at least one DMRS port group has different QCL assumptions, which indicates that each of the at least one DMRS port group has different QCL assumptions, for example, a certain DMRS port group has a first QCL assumption and a second QCL assumption, or different DMRS port groups in the at least one DMRS port group have different QCL assumptions, for example, the at least one DMRS port group includes a first DMRS port group and a second DMRS port group, the first DMRS port group has a first QCL assumption, and the second DMRS port group has a second QCL assumption.

In this way, prior to the terminal device transmitting the first uplink information on the first resource and the terminal device transmitting the second uplink information on the second resource, the method further includes that the terminal device determines a transmission scheme of the first uplink information and/or the second uplink information. The transmission scheme includes one or more of: codeword information, the number of transmission layers, an RV version, a DMRS port, a DMRS port group, or an association between PT-RS and DMRS. Different resource allocation schemes are associated with the transmission scheme, such that the information from multiple panels is transmitted simultaneously.

It should be noted that at least one resource in the above embodiments refers to the resource for transmitting the at least one uplink information, when not otherwise specified.

FIG. 13 is a flowchart diagram of another communication method according to some embodiments of the present disclosure. As shown in FIG. 13, the method includes the following processes.

In S1301, a network device receives at least one uplink information on at least one resource.

The at least one resource includes at least one of: a time domain resource, a frequency domain resource, a code domain resource, or a spatial domain resource.

The at least one uplink information includes at least one of: one or more PUCCHs, one or more PUSCHs, one or more transmission layers corresponding to the PUCCHs, one or more transmission layers corresponding to the PUSCHs, one or more RVs corresponding to the PUSCHs, one or more transport blocks, one or more RVs corresponding to the transport blocks, or one or more reference signals.

In some embodiments, the description of the at least one resource for receiving the at least one uplink information corresponds to the description of the at least one resource for transmitting the at least one uplink information described above. That is, the description of the at least one resource for receiving the at least one uplink information is interpreted with reference to the description of the at least one resource for transmitting the at least one uplink information, which is not further repeated herein.

In some embodiments, the network device determines at least one resource, and the network device receives at least one uplink information on the at least one resource.

In some embodiments, the at least one resource is determined based on a resource scheduled by one or more DCI, or the at least one resource is determined based on a resource configured by higher layer signaling.

For example, the at least one resource for receiving the at least one uplink information is determined based on at least one resource that is configured to transmit the at least one uplink information and scheduled by the one or more DCI, or the at least one resource for receiving the at least one uplink information is determined based on at least one resource that is configured by the higher layer signaling and configured to transmit the at least one uplink information.

In some embodiments, different uplink information in the at least one uplink information is associated with different spatial information.

The spatial information includes at least one of: antenna panel information, TRP information, CORESET group information, reference signal set information, TCI state information, beam information, or capability set information.

In some embodiments, the at least one resource includes at least one of: at least one FDM resource, at least one SDM resource, at least one CDM resource, or at least one TDM resource.

In some embodiments, the at least one resource includes a non-frequency hopping resource.

In some embodiments, the at least one resource includes a third resource and a fourth resource.

The third resource belongs to a third resource set and the fourth resource belongs to a fourth resource set.

The third resource set and/or the fourth resource set includes one or more resource block groups (RBGs), or, the third resource set and/or the fourth resource set includes one or more RBs.

In some embodiments, the description of the third resource, the fourth resource, the third resource set, and the fourth resource set corresponds to the description of the first resource, the second resource, the first resource set, and the second resource set as described above. That is, the description of the third resource, the fourth resource, the third resource set, and the fourth resource set is interpreted with reference to the description of the first resource, the second resource, the first resource set, and the second resource set, which is not repeated herein.

In some embodiments, indexes of one or more RBGs included in the third resource set are smaller than indexes of one or more RBGs included in the fourth resource set; or
the indexes of one or more RBGs included in the third resource set are even numbers, and the indexes of one or more RBGs included in the fourth resource set are odd numbers; or
the indexes of the plurality of RBGs included in the third resource set and/or the fourth resource set are partially consecutive, and the number of contiguous RBGs is at least two; or
indexes of one or more RBs included in the third resource set are smaller than indexes of one or more RBs included in the fourth resource set; or
the indexes of one or more RBs included in the third resource set are even numbers, and the indexes of one or more RBs included in the fourth resource set are odd numbers; or
the indexes of the plurality of RBs included the third resource set and/or the fourth resource set are partially consecutive, and the number of contiguous RBs is at least two.

In some embodiments, the third resource is determined based on the third resource set and a third bitmap, and/or the fourth resource is determined based on the fourth resource set and a fourth bitmap.

The third bitmap is the same as or different from the first bitmap. The fourth bitmap is the same as or different from the second bitmap.

In some embodiments, a location of a starting RB of the third resource set and/or the fourth resource set is a location of a first RB of a bandwidth part BWP; or
the location of the starting RB of the third resource set and/or the fourth resource set is a location of a common resource block (CRB) 0; or
the location of the starting RB of the third resource set and/or the fourth resource set is a location of Point A.

In some embodiments, in the case that a waveform of the at least one uplink information is DFT-S-OFDM, the RBGs or RBs included in each of the at least one resource are contiguous, or the RBGs or RBs included in each of the at least one resource are non-contiguous.

In the case that the waveform of the at least one uplink information is CP-OFDM, the RBGs or RBs included in each of the at least one resource are contiguous, or the RBGs or RBs included in each of the at least one resource are almost contiguous.

In some embodiments, the at least one resource includes a frequency hopping resource.

In some embodiments, the at least one resource includes a third resource and a fourth resource. The third resource includes a fifth frequency hopping resource and a sixth frequency hopping resource. The fourth resource includes a seventh frequency hopping resource and an eighth frequency hopping resource.

A starting RB index of the seventh frequency hopping resource is the sum of a starting RB index of the fifth frequency hopping resource and the number of RBs of the fifth frequency hopping resource.

A starting RB index of the eighth frequency hopping resource is the sum of a starting RB index of the sixth frequency hopping resource and the number of RBs of the sixth frequency hopping resource.

In some embodiments, spatial information associated with the third resource is different from spatial information associated with the fourth resource.

The spatial information includes at least one of: panel information, CORESET group information, reference signal set information, TCI state information, beam information, or capability set information.

In some embodiments, the number of RBs of the fifth frequency hopping resource and/or the number of RBs of the sixth frequency hopping resource is ┌L_{RB}/2), and the number of RBs of the seventh frequency hopping resource and/or the number of RBs of the eighth frequency hopping resource is ┌L_{RB}/2┘, or is a result of L_{RB} minus the number of RBs of the fifth frequency hopping resource or the sixth frequency hopping resource; or
the number of RBs of the fifth frequency hopping resource and/or the number of RBs of the sixth frequency hopping resource is ┌L_{RB}/2┘, and the number of RBs of the seventh frequency hopping resource and/or the number of RBs of the eighth frequency hopping resource is ┌L_{RB}/2┘, or is a result of L_{RB} minus the number of RBs of the fifth frequency hopping resource or the number of RBs of the sixth frequency hopping resource.

L_{RB} is the total number of RBs allocated to the terminal device.

In some embodiments, the starting RB index of the fifth frequency hopping resource is RBₛₜₐᵣₜ.

The starting RB index of the sixth frequency hopping resource is (RBₛₜₐᵣₜ+RB_{offset})modN_{BWP}^{size}. RB_{offset} represents a frequency offset in RBs between frequency hops, and N_{BWP}^{size} represents the number of RBs of the uplink activated BWP.

The starting RB index of the seventh frequency hopping resource is RBₛₜₐᵣₜ+┌L_{RB}/2┘ or Rstart+┌L_{RB}/2┐. L_{RB} represents the total number of RBs allocated to the terminal device.

The starting RB index of the eighth frequency hopping resource is (RBₛₜₐᵣₜ+RB_{offset})modN_{BWP}^{size}+┌L_{RB}/2┘ or (RBₛₜₐᵣₜ+RB_{offset})modN_{BWP}^{size}+┌L_{RB}/2┐.

In some embodiments, the starting RB index of the fifth frequency hopping resource is RBₛₜₐᵣₜ.

The starting RB index of the sixth frequency hopping resource is (RBₛₜₐᵣₜ+RB_{offset})modN_{BWP}^{size}. RB_{offset} represents a frequency offset in RBs between frequency hops, and N_{BWP}^{size} represents the number of RBs of the uplink activated BWP.

The starting RB index of the seventh frequency hopping resource is RBₛₜₐᵣₜ+RB_{offset1}. RB_{offset} is predefined, indicated by the DCI, or indicated by a radio resource control (RRC).

The starting RB index of the eighth frequency hopping resource is (RBₛₜₐᵣₜ+RB_{offset}+RB_{offset1})modN_{BWP}^{size}.

In some embodiments, one of the fifth frequency hopping resource and the seventh frequency hopping resource includes contiguous RB resources and the other is an interlace resource; and/or, one of the sixth frequency hopping resource and the eighth frequency hopping resource includes contiguous RB resources and the other is an interlace resource.

In some embodiments, the description of the fifth to eighth frequency hopping resources correspond to the above description of the first to fourth frequency hopping resources. That is, the description of the fifth to eighth frequency hopping resources is interpreted with reference to the description of the first to fourth frequency hopping resources, which is not repeated herein.

In some embodiments, the at least one resource includes a third resource and a fourth resource.

The number of RBs of the third resource and/or the number of RBs of the fourth resource is L_{RB}. L_{RB} is the total number of RBs allocated to the terminal device; and/or
a starting RB index of the third resource is RBₛₜₐᵣₜ and a starting RB index of the fourth resource is (RBₛₜₐᵣₜ+RB_{offset})modN_{BWP}^{size}. RBₛₜₐᵣₜ represents a frequency offset in RBs between frequency hops, and N_{BWP}^{size} represents the number of RBs of the uplink activated BWP.

In some embodiments, at least a portion of the at least one resource is an interlace resource.

In some embodiments, the at least the portion of the at least one resource is the interlace resource, and/or interlace configuration information of the at least the portion of the at least one resource is configured by protocol predefined information, pre-configuration information, or network configuration information.

In some embodiments, the interlace configuration information of the at least the portion of the at least one resource is related to a subcarrier spacing and/or a granularity of the interlace. The granularity of the interlace is the number of RBs included in one interlace.

In some embodiments, the at least one resource includes K resources, and the K resources occupy contiguous M×N RBs in a frequency domain.

Each of the K resources includes N sub-resources. RB locations of adjacent two sub-resources in each resource are spaced apart from each other by M RBs. The K sub-resources that are contiguous in the frequency domain occupy M RBs. K and N are integers greater than or equal to 2, and M is an integer multiple of the K.

In some embodiments, the at least one uplink information is associated with at least one of: a codeword, the number of transmission layers, an RV, a DMRS port, a DMRS port group, a PT-RS, or a DMRS.

In some embodiments, different uplink information in the at least one uplink information is associated with the same codeword; or
different uplink information in the at least one uplink information is associated with different codewords; or
one portion of the at least one uplink information is associated with the same codeword, and different uplink information in another portion of the at least one uplink information is associated with different codewords.

In some embodiments, the same number of transmission layers are employed for different uplink information in the at least one uplink information; or
different numbers of transmission layers are employed for different uplink information in the at least one uplink information; or
the same number of transmission layers are employed for one portion of the at least one uplink information, and different numbers of transmission layers are employed for different uplink information another portion of the at least one uplink information.

In some embodiments, the at least one uplink information is associated with a first codeword, and the first codeword maps all transmission layers for the at least one uplink information.

In some embodiments, the at least one uplink information includes first uplink information and second uplink information.

The first uplink information is associated with a second codeword, and the second codeword maps transmission layers for the first uplink information.

The second uplink information is associated with a third codeword, and the third codeword maps transmission layers for the second uplink information.

In some embodiments, the number of transmission layers for the at least one uplink information is indicated by first information; or
the number of transmission layers for one portion of the at least one uplink information is indicated by the first information, and the number of transmission layers for another portion of the at least one uplink information is determined in accordance with a predefined rule; or
the number of transmission layers for one portion of the at least one uplink information is indicated by the first information, and the number of transmission layers for another portion of the at least one uplink information is indicated by second information.

The first information and/or the second information is RRC signaling or DCI, or the first information and the second information are different fields in the RRC signaling or are different fields in the DCI.

In some embodiments, the at least one uplink information is in one-to-one association with at least one DMRS port group; or
the at least one uplink information is in many-to-one association with at least one DMRS port group.

In some embodiments, the at least one uplink information includes first uplink information and second uplink information.

A transmission layer for the first uplink information is associated with a first DMRS port group, and a transmission layer for the second uplink information is associated with a second DMRS port group.

In some embodiments, the DMRS port group associated with the at least one uplink information is indicated by different indication information, or by different fields of the same indication information, or by the same field of the same indication information.

In some embodiments, different uplink information in the at least one uplink information is associated with different DMRS ports in the same DMRS port group.

In some embodiments, the at least one uplink information includes first uplink information and second uplink information.

A transmission layer for the first uplink information is associated with a first DMRS port set in the at least one DMRS port group.

A transmission layer for the second uplink information is associated with a second DMRS port set in the at least one DMRS port group.

The number of DMRS ports included in the first DMRS port set is the same as the number of transmission layers for the first uplink information, and the number of DMRS ports included in the second DMRS port set is the same as the number of transmission layers for the second uplink information.

In some embodiments, the at least one DMRS port group is associated with one or more TCI states, or has one or more QCL assumptions.

It should be noted that the at least one resource in the above embodiments refers to a resource for receiving the at least one uplink information, in all cases where the at least one resource is not specifically described.

The preferred embodiments of the present disclosure are described in detail above in conjunction with the accompanying drawings. However, the present disclosure is not limited to the specific details in the above embodiments, and a variety of simple variations of the technical solutions of the present disclosure may be performed within the scope of the technical conception of the present disclosure, and all of these simple variations fall within the scope of protection of the present disclosure. For example, the various specific technical features described in the above-described specific embodiments may be combined in any suitable manner without contradiction, and to avoid unnecessary repetition, the present disclosure does not separately describe the various possible ways of combinations. For example, the various embodiments of the present disclosure can be combined in any way, and they should be regarded as the contents disclosed in the present disclosure as long as they do not contradict the idea of the present disclosure. For example, on the premise of no conflict, the various embodiments and/or the technical features in the various embodiments described in the present disclosure may be arbitrarily combined with the related art, and the technical solutions acquired after the combination shall also fall within the scope of protection of the present disclosure.

It should also be understood that in the various method embodiments of the present disclosure, the serial numbers of the processes described above do not imply the execution sequence, and the execution sequence among the processes shall be determined by their functions and internal logic, and shall not constitute any limitation to the implementation processes of the embodiments of the present disclosure. Furthermore, in the embodiments of the present disclosure, the terms “downlink”, “uplink”, and “sidelink” indicate a transmission direction of a signal or data, wherein the term “downlink” indicates that the signal or data is transmitted in a first direction from a site to user equipment of a cell, the term “uplink” indicates that the signal or data is transmitted in a second direction from user equipment of a cell to a site, and the term “sidelink” indicates that the signal or data is transmitted in a third direction from user equipment 1 to user equipment 2. For example, the term “downlink signal” indicates that the transmission direction of the signal is the first direction. In addition, in the embodiments of the present disclosure, the term “and/or” merely describes an association relationship of the associated objects, and indicates three types relationships. Specifically, the phrase “A and/or B” means (A), (B), or (A and B). In addition, the symbol “/” herein usually indicates an “or” relationship between the associated objects.

FIG. 14 is a schematic structural diagram of a communication apparatus according to some embodiments of the present disclosure, which is applicable to a terminal device. As shown in FIG. 14, the communication apparatus 1400 includes a transceiver unit 1401.

The transceiver unit 1401 is configured to transmit at least one uplink information on at least one resource.

The at least one resource includes at least one of: a time domain resource, a frequency domain resource, a code domain resource, or a spatial domain resource.

The at least one uplink information includes at least one of: one or more PUCCHs, one or more PUSCHs, one or more transmission layers corresponding to the PUCCHs, one or more transmission layers corresponding to the PUSCHs, one or more RVs corresponding to the PUSCHs, one or more transport blocks, one or more RVs corresponding the transport block, or one or more reference signals.

In some embodiments, the communication apparatus 1400 further includes a determination unit configured to determine at least one resource.

In some embodiments, the at least one resource is scheduled by one or more DCI, or the at least one resource is configured by higher layer signaling.

In some embodiments, different uplink information in the at least one uplink information is associated with different spatial information.

The spatial information includes at least one of: antenna panel information, TRP information, CORESET group information, reference signal set information, TCI state information, beam information, or capability set information.

In some embodiments, the at least one resource includes at least one of: at least one FDM resource, at least one SDM resource, at least one CDM resource, or at least one TDM resource.

In some embodiments, the at least one resource includes a non-frequency hopping resource.

In some embodiments, the at least one resource includes a first resource and a second resource.

The first resource belongs to a first resource set and the second resource belongs to a second resource set.

The first resource set and/or the second resource set includes one or more resource block groups (RBGs), or, the first resource set and/or the second resource set includes one or more RBs.

In some embodiments, indexes of one or more RBGs included in the first resource set are smaller than indexes of one or more RBGs included in the second resource set; or, the indexes of one or more RBGs included in the first resource set are even numbers and the indexes of one or more RBGs included in the second resource set are odd numbers; or, the indexes of a plurality of RBGs in the first resource set and/or the second resource set are partially consecutive and the number of contiguous RBGs is at least two; or, the indexes of one or more RBs included in the first resource set are smaller than the indexes of one or more RBs included in the second resource set; or, the indexes of one or more RBs included in the first resource set are even numbers and the indexes of one or more RBs included in the second resource set are odd numbers; or, the indexes of a plurality of RGs in the first resource set and/or the second resource set are partially consecutive and the number of contiguous RGs is at least two.

In some embodiments, the first resource is determined based on the first resource set and a first bitmap, and/or, the second resource is determined based on the second resource set and a second bitmap.

In some embodiments, a location of a starting RB of the first resource set and/or the second resource set is a location of a first RB of a BWP; or, the location of the starting RB of the first resource set and/or the second resource set is a location of a common resource block (CRB) 0; or, the location of the starting RB of the first resource set and/or the second resource set is a location of Point A.

In some embodiments, in the case that a waveform of the at least one uplink information is DFT-S-OFDM, the RBGs or RBs included in each of the at least one resource are contiguous, or the RBGs or RBs included in each of the at least one resource are non-contiguous.

In the case that the waveform of the at least one uplink information is CP-OFDM, the RBGs or RBs included in each of the at least one resource are contiguous, or the RBGs or RBs included in each of the at least one resource are almost contiguous.

In some embodiments, the at least one resource includes a frequency hopping resource.

In some embodiments, the at least one resource includes a first resource and a second resource. The first resource includes a first frequency hopping resource and a second frequency hopping resource, and the second resource includes a third frequency hopping resource and a fourth frequency hopping resource. A starting RB index of the third frequency hopping resource is the sum of a starting RB index of the first frequency hopping resource and the number of RBs of the first frequency hopping resource. A starting RB index of the fourth frequency hopping resource is the sum of a starting RB index of the second frequency hopping resource and the number of RBs of the second frequency hopping resource.

In some embodiments, spatial information associated with the first resource is different from spatial information associated with the second resource. The spatial information includes at least one of panel information, CORESET group information, reference signal set information, TCI state information, beam information, or capability set information.

In some embodiments, the number of RBs of the first frequency hopping resource and/or the number of RBs of the second frequency hopping resource is ┌L_{RB}/2┘, and the number of RBs of the third frequency hopping resource and/or the number of RBs of the fourth frequency hopping resource is ┌L_{RB}/2┘ or is a result of L_{RB} minus the number of RBs of the first frequency hopping resource or the second frequency hopping resource. Alternatively, the number of RBs of the first frequency hopping resource and/or the number of RBs of the second frequency hopping resource is ┌L_{RB}/2┘ and the number of RBs of the third frequency hopping resource and/or the number of RBs of the fourth frequency hopping resource is ┌L_{RB}/2┘ or is a result of L_{RB} minus the number of RBs of the first frequency hopping resource or the second frequency hopping resource. L_{RB} is the total number of RBs allocated to the terminal device.

In some embodiments, the starting RB index of the first frequency hopping resource is: RBₛₜₐᵣₜ; the starting RB index of the second frequency hopping resource is (RBₛₜₐᵣₜ+RB_{offset})modN_{BWP}^{size}, wherein RB_{offset} represents a frequency offset in RBs between frequency hops, and N_{BWP}^{size} is the number of RBs of uplink activated BWP; the starting RB index of the third hopping resource is RBₛₜₐᵣₜ+┌L_{RB}/2┘ or RBₛₜₐᵣₜ+┌L_{RB}/2┘, wherein L_{RB} is the total number of RBs allocated to the terminal device; and the starting RB index of the fourth frequency hopping resource is (RBₛₜₐᵣₜ+RB_{offset})modN_{BWP}^{size}+┌L_{RB}/2┘ or (RBₛₜₐᵣₜ+RB_{offset})modN_{BWP}^{size}+┌L_{RB}/2┐.

In some embodiments, the starting RB index of the first frequency hopping resource is RBₛₜₐᵣₜ; the starting RB index of the second frequency hopping resource is (RBₛₜₐᵣₜ+RB_{offset})modN_{BWP}^{size}, wherein RB_{offset} represents a frequency offset in RBs between frequency hops, and Nsizₚ represents the number of RBs of uplink activated BWP; the starting RB index of the third frequency hopping resource is RBₛₜₐᵣₜ+RB_{offset1}, wherein RB_{offset1} is predefined, indicated by the DCI, or indicated by a radio resource control (RRC); and the starting RB index of the fourth frequency hopping resource is (RBₛₜₐᵣₜ+RB_{offset}+RB_{offset1})modN_{BWP}^{size}.

In some embodiments, one of the first frequency hopping resource and the third frequency hopping resource includes contiguous RB resources and the other is an interlace resource; and/or, one of the second frequency hopping resource and the fourth frequency hopping resource includes contiguous RB resources and the other is an interlace resource.

In some embodiments, the at least one resource includes a first resource and a second resource; the number of RBs of the first resource and/or the number of RBs of the second resource is L_{RB}, wherein L_{RB} is the total number of RBs allocated to the terminal device; and/or, a starting RB index of the first resource is RBₛₜₐᵣₜ and a starting RB index of the second resource is (RBₛₜₐᵣₜ+RB_{offset})modN_{BWP}^{size}, wherein RB_{offset} represents a frequency offset in RBs between frequency hops, and N_{BWP}^{size} represents the number of RBs of the uplink activated BWP.

In some embodiments, at least the portion of the at least one resource is the interlace resource.

In some embodiments, the at least the portion of the at least one resource is the interlace resource, and/or interlace configuration information of the at least the portion of the at least one resource is configured by protocol predefined information, pre-configuration information, or network configuration information.

In some embodiments, the interlace configuration information of the at least the portion of the at least one resource is related to a subcarrier spacing and/or a granularity of the interlace. The granularity of the interlace is the number of RBs included in one interlace.

In some embodiments, the at least one resource includes K resources, and the K resources occupy contiguous M×N RBs in the frequency domain. Each of the K resources includes N sub-resources, RB locations of adjacent two of the N sub-resources in the each of the K resources are spaced apart from each other by M RBs, and the contiguous K sub-resources in the frequency domain occupy M RBs. K and N are integers greater than or equal to 2, and M is an integer multiple of the K.

In some embodiments, the at least one uplink information is associated with at least one of: a codeword, the number of transmission layers, an RV, a DMRS port, a DMRS port group, a PT-RS, or a DMRS.

In some embodiments, different uplink information in the at least one uplink information is associated with the same codeword; or, different uplink information in the at least one uplink information is associated with different codewords; or, one portion of the at least one uplink information is associated with the same codeword, and different uplink information of another portion of at least one uplink information is associated with different codewords.

In some embodiments, the same number of transmission layers are employed for different uplink information in the at least one uplink information; or, different numbers of transmission layers are employed for different uplink information in the at least one uplink information; or, the same number of transmission layers are employed for one portion of the at least one uplink information, and different numbers of transmission layers are employed for different uplink information in another portion of the at least one uplink information.

In some embodiments, the at least one uplink information is associated with a first codeword, wherein the first codeword maps all transmission layers for the at least one uplink information.

In some embodiments, the at least one uplink information includes first uplink information and second uplink information.

The first uplink information is associated with a second codeword, and the second codeword maps transmission layers for the first uplink information.

The second uplink information is associated with a third codeword, and the third codeword maps transmission layers for the second uplink information.

In some embodiments, the number of transmission layers for the at least one uplink information is indicated by first information; or
the number of transmission layers for one portion of the at least one uplink information is indicated by the first information and the number of transmission layers for another portion of the at least one uplink information is determined in accordance with a predefined rule; or
the number of transmission layers for one portion of the at least one uplink information is indicated by the first information, and the number of transmission layers for another portion of the at least one uplink information is indicated by the second information.

The first information and/or the second information is RRC signaling or DCI, or the first information and the second information are different fields in the RRC signaling or are different fields in the DCI.

In some embodiments, the at least one uplink information is in one-to-one association with at least one DMRS port group; or
the at least one uplink information is in many-to-one association with at least one DMRS port group.

In some embodiments, the at least one uplink information includes first uplink information and second uplink information;

A transmission layer for the first uplink information is associated with a first DMRS port group, and a transmission layer for the second uplink information is associated with a second DMRS port group.

In some embodiments, the DMRS port group associated with the at least one uplink information is indicated by different indication information, or by different fields of the same indication information, or by the same field of the same indication information.

In some embodiments, different uplink information in the at least one uplink information is associated with different DMRS ports in the same DMRS port group.

In some embodiments, the at least one uplink information includes first uplink information and second uplink information.

A transmission layer for the first uplink information is associated with a first DMRS port set in the at least one DMRS port group.

A transmission layer for the second uplink information is associated with a second DMRS port set in the at least one DMRS port group.

The number of DMRS ports in the first DMRS port set is the same as the number of transmission layers for the first uplink information, and the number of DMRS ports in the second DMRS port set is the same as the number of transmission layers for the second uplink information.

In some embodiments, the at least one DMRS port group is associated with one or more TCI states or has one or more QCL assumptions.

FIG. 15 is a schematic structural diagram of another communication apparatus according to some embodiments of the present disclosure, applicable to a network device. As shown in FIG. 15, the communication apparatus 1500 includes:
a transceiver unit 1501, configured to receive at least one uplink information on at least one resource;
the at least one resource includes at least one of: a time domain resource, a frequency domain resource, a code domain resource, or a spatial domain resource; and
the at least one uplink information includes at least one of: one or more PUCCHs, one or more PUSCHs, one or more transmission layers corresponding to the PUCCHs, one or more transmission layers corresponding to the PUSCHs, one or more RVs corresponding to the PUSCHs, one or more transport blocks, one or more RVs corresponding to the transport blocks, or one or more reference signals.

In some embodiments, the communication apparatus 1500 further includes a determination unit configured to determine at least one resource.

In some embodiments, the at least one resource is determined based on a resource scheduled by one or more DCI, or the at least one resource is determined based on a resource configured by a higher layer signaling.

In some embodiments, different uplink information in the at least one uplink information is associated with different spatial information.

The spatial information includes at least one of: antenna panel information, TRP information, CORESET group information, reference signal set information, TCI state information, beam information, or capability set information.

In some embodiments, the at least one resource includes at least one of: at least one FDM resource, at least one SDM resource, at least one CDM resource, or at least one TDM resource.

In some embodiments, the at least one resource includes a non-frequency hopping resource.

In some embodiments, the at least one resource includes a third resource and a fourth resource.

The third resource belongs to a third resource set and the fourth resource belongs to a fourth resource set.

The third resource set and/or the fourth resource set includes one or more resource block groups (RBGs), or, the third resource set and/or the fourth resource set includes one or more RBs.

In some embodiments, indexes of one or more RBGs included in the third resource set are smaller than indexes of one or more RBGs included in the fourth resource set; or
the indexes of one or more RBGs included in the third resource set are even numbers, and the indexes of one or more RBGs included in the fourth resource set are odd numbers; or
the indexes of the plurality of RBGs included in the third resource set and/or the fourth resource set are partially consecutive and the number of contiguous RBGs is at least two; or
indexes of one or more RBs included in the third resource set are smaller than indexes of one or more RBs included in the fourth resource set;
the indexes of one or more RBs included in the third resource set are even numbers, and the indexes of one or more RBs included in the fourth resource set are odd numbers; or
the indexes of the plurality of RBGs of the third resource set and/or the fourth resource set are partially consecutive and the number of contiguous RBs is at least two.

In some embodiments, the third resource is determined based on the third resource set and a third bitmap, and/or the fourth resource is determined based on the fourth resource set and a fourth bitmap.

In some embodiments, a location of the starting RB of the third resource set and/or the fourth resource set is a location of a first RB of a BWP; or
the location of the starting RB of the third resource set and/or the fourth resource set is a location of a common resource block (CRB) 0; or
the location of the starting RB of the third resource set and/or the fourth resource set is a location of Point A.

In some embodiments, in the case that a waveform of the at least one uplink information is DFT-S-OFDM, the RBGs or RBs included in each of the at least one resource are contiguous, or the RBGs or RBs included in each of the at least one resource are non-contiguous.

In the case that the waveform of the at least one uplink information is CP-OFDM, the RBGs or RBs included in each of the at least one resource are contiguous, or the RBGs or RBs included in each of the at least one resource are almost contiguous.

In some embodiments, the at least one resource includes a frequency hopping resource.

In some embodiments, the at least one resource includes a third resource and a fourth resource. The third resource includes a fifth frequency hopping resource and a sixth frequency hopping resource, and the fourth resource includes a seventh frequency hopping resource and an eighth frequency hopping resource.

A starting RB index of the seventh frequency hopping resource is the sum of a starting RB index of the fifth frequency hopping resource and the number of RBs of the fifth frequency hopping resource.

A starting RB index of the eighth frequency hopping resource is the sum of a starting RB index of the sixth frequency hopping resource and the number of RBs of the sixth frequency hopping resource.

In some embodiments, spatial information associated with the third resource is different from spatial information associated with the fourth resource.

The spatial information includes at least one of: panel information, CORESET group information, reference signal set information, TCI state information, beam information, or capability set information.

In some embodiments, the number of RBs of the fifth frequency hopping resource and/or the number of RBs of the sixth frequency hopping resource is ┌L_{RB}/2┘, and the number of RBs of the seventh frequency hopping resource and/or the number of RBs of the eighth frequency hopping resource is ┌L_{RB}/2┐, or is a result of L_{RB} minus the number of RBs of the fifth frequency hopping resource or the sixth frequency hopping resource; or
the number of RBs of the fifth frequency hopping resource and/or the number of RBs of the sixth frequency hopping resource is ┌L_{RB}/2┐, and the number of RBs of the seventh frequency hopping resource and/or the number of RBs of the eighth frequency hopping resource is ┌L_{RB}/2┘, or is a result of L_{RB} minus the number of RBs of the fifth frequency hopping resource or the number of RBs of the sixth frequency hopping resource
L_{RB} is the total number of RBs allocated to the terminal device.

In some embodiments, the starting RB index of the fifth frequency hopping resource is RBₛₜₐᵣₜ.

The starting RB index of the sixth frequency hopping resource is (RBₛₜₐᵣₜ+RB_{offset})modN_{BWP}^{size}. RB_{offset} represents a frequency offset in RBs between frequency hops, and N_{BWP}^{size} represents the number of RBs of the uplink activated BWP.

The starting RB index of the seventh frequency hopping resource is RBₛₜₐᵣₜ+┌L_{RB}/2┘ or RBₛₜₐᵣₜ+┌L_{RB}/2┐. The L_{RB} is the total number of RBs allocated to the terminal device.

The starting RB index of the eighth frequency hopping resource is (RBₛₜₐᵣₜ+RB_{offset})modN_{BWP}^{size}+┌L_{RB}/2┘ or (RBₛₜₐᵣₜ+RB_{offset})modN_{BWP}^{size}+┌L_{RB}/2┘.

In some embodiments, the starting RB index of the fifth frequency hopping resource is RBₛₜₐᵣₜ.

The starting RB index of the sixth frequency hopping resource is (RBₛₜₐᵣₜ+RB_{offset})modN_{BWP}^{size}. RB_{offset} represents a frequency offset in RBs between frequency hops, and N_{BWP}^{size} represents the number of RBs of the uplink activated BWP.

The starting RB index of the seventh frequency hopping resource is RBₛₜₐᵣₜ+RB_{offset1}. RB_{offset1} is predefined, indicated by the DCI, or indicated by a radio resource control (RRC).

The starting RB index of the eighth frequency hopping resource is (RBₛₜₐᵣₜ+RB_{offset}+RB_{offset1})modN_{BWP}^{size}.

In some embodiments, one of the fifth frequency hopping resource and the seventh frequency hopping resource includes contiguous RB resources and the other is an interlace resource; and/or, one of the sixth frequency hopping resource and the eighth frequency hopping resource includes contiguous RB resources and the other is an interlace resource.

In some embodiments, the at least one resource includes a third resource and a fourth resource.

The number of RBs of the third resource and/or the number of RBs of the fourth resource is L_{RB}. L_{RB} is the total number of RBs allocated to the terminal device; and/or
a starting RB index of the third resource is RBₛₜₐᵣₜ and a starting RB index of the fourth resource is (RBₛₜₐᵣₜ+RB_{offset})modN_{BWP}^{size}. RB_{offset} represents a frequency offset in RBs between frequency hops, and N_{BWP}^{size} represents the number of RBs of the uplink activated BWP.

In some embodiments, at least a portion of the at least one resource is an interlace resource.

In some embodiments, the at least the portion of the at least one resource is the interlace resource, and/or interlace configuration information of the at least the portion of the at least one resource is configured by protocol predefined information, pre-configuration information, or network configuration information.

In some embodiments, the interlace configuration information of the at least the portion of the at least one resource is related to a subcarrier spacing and/or a granularity of the interlace. The granularity of the interlace is the number of RBs included in one interlace.

In some embodiments, the at least one resource includes K resources, and the K resources occupy contiguous M×N RBs in a frequency domain.

Each of the K resources includes N sub-resources, and RB locations of adjacent two of the N sub-resources in the each of the K resources are spaced apart from each other by M RBs. The K sub-resources that are contiguous in the frequency domain occupy M RBs. K and N are integers greater than or equal to 2, and M is an integer multiple of the K.

In some embodiments, the at least one uplink information is associated with at least one of: a codeword, the number of transmission layers, an RV, a DMRS port, a DMRS port group, a PT-RS, or a DMRS.

In some embodiments, different uplink information in the at least one uplink information is associated the same codeword; or
different uplink information in the at least one uplink information is associated with different codewords; or
one portion of the at least one uplink information is associated the same codeword, and different uplink information in another portion of the at least one uplink information is associated with different codewords.

In some embodiments, the same number of transmission layers are employed for different uplink information in the at least one uplink information; or
different numbers of transmission layers are employed for different uplink information in the at least one uplink information; or
the same number of transmission layers are employed for one portion of the at least one uplink information, and different numbers of transmission layers are employed for different uplink information in another portion of the at least one uplink information.

In some embodiments, the at least one uplink information is associated with a first codeword, and the first codeword maps all transmission layers for the at least one uplink information.

In some embodiments, the at least one uplink information includes first uplink information and second uplink information.

The first uplink information is associated with a second codeword, and the second codeword maps transmission layers for the first uplink information.

The second uplink information is associated with a third codeword, and the third codeword maps transmission layers for the second uplink information.

In some embodiments, the number of transmission layers for the at least one uplink information is indicated by first information; or
the number of transmission layers for a portion of the at least one uplink information is indicated by the first information, and the number of transmission layers for another portion of the at least one uplink information is determined in accordance with a predefined rule; or
the number of transmission layers for a portion the at least one uplink information is indicated by the first information, and the number of transmission layers for another portion of the at least one uplink information is indicated by second information.

The first information and/or the second information is RRC signaling or DCI, or the first information and the second information are different fields in RRC signaling or are different fields in DCI.

In some embodiments, the at least one uplink information is in one-to-one association with at least one DMRS port group; or
the at least one uplink information is in many-to-one association with at least one DMRS port group.

In some embodiments, the at least one uplink information includes first uplink information and second uplink information.

The transmission layer for the first uplink information is associated with a first DMRS port group, and the transmission layer for the second uplink information is associated with a second DMRS port group.

In some embodiments, the DMRS port group associated with the at least one uplink information is indicated by different indication information, or by different fields of the same indication information, or by the same field of the same indication information.

In some embodiments, different uplink information in the at least one uplink information is associated with different DMRS ports in the same DMRS port group.

In some embodiments, the at least one uplink information includes first uplink information and second uplink information.

The transmission layer for the first uplink information is associated with a first DMRS port set in the at least one DMRS port group.

The transmission layer for the second uplink information is associated with a second DMRS port set in the at least one DMRS port group.

The number of DMRS ports included in the first DMRS port set is the same as the number of transmission layers for the first uplink information, and the number of DMRS ports included in the second DMRS port set is the same as the number of transmission layers for the second uplink information.

In some embodiments, at least one DMRS port group is associated with one or more TCI states or has one or more QCL assumptions.

It should be understood by those skilled in the art that the above description of the communication apparatus of the embodiments of the present disclosure shall be understood with reference to the description of the communication method of the embodiments of the present disclosure.

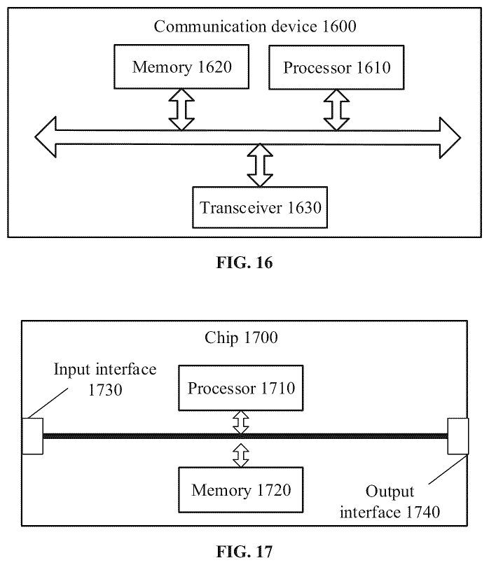

FIG. 16 is a schematic structural diagram of a communication device according to some embodiments of the present disclosure. The communication device includes a terminal device or a network device. The communication device 1600 shown in FIG. 16 includes a processor 1610 and a memory 1620. The memory 1620 is configured to store at least one computer program, and the processor 1610 is configured to load and run the at least one computer program stored in the memory 1620 to perform the communication method according to the above embodiments.

The memory 1620 is a separate device from the processor 1610 or is integrated into the processor 1610.

In some embodiments, as shown in FIG. 16, the communication device 1600 further includes a transceiver 1630. The processor 1610 controls the transceiver 1630 to communicate with other devices, specifically, to transmit information or data to other devices, or to receive information or data from other devices.

The transceiver 1630 includes a transmitter and a receiver. The transceiver 1630 further includes an antenna, and the number of antennas is one or more.

In some embodiments, the communication device 1600 implements the corresponding processes implemented by the communication device in the various methods according to the embodiments of the present disclosure, which are not repeated herein for brevity.

FIG. 17 is a schematic structural diagram of a chip according to some embodiments of the present disclosure. The chip 1700 shown in FIG. 17 includes a processor 1710. The processor 1710, when loading and running at least one computer program from memory, causes a device equipped with the chip to perform the method in the embodiments of the present disclosure.

In some embodiments, the chip 1700, as shown in FIG. 17, further includes a memory 1720. The processor 1710, when loading and running at least one computer program from the memory 1720, is caused to perform the method in the embodiments of the present disclosure.

The memory 1720 is a separate device from the processor 1710 or is integrated into the processor 1710.

In some embodiments, the chip 1700 further includes an input interface 1730. The processor 1710 controls the input interface 1730 to communicate with other devices or chips, specifically, to acquire information or data from other devices or chips.

In some embodiments, the chip 1700 further includes an output interface 1740. The processor 1710 controls the output interface 1740 to communicate with the other device or chip, specifically, to output information or data to the other device or chip.

In some embodiments, the chip is applicable to the terminal device in some embodiments of the present disclosure, and the chip implements the corresponding processes implemented by the terminal device in the various methods according to the embodiments of the present disclosure, which are not repeated herein for brevity.

It should be understood that the chip referred to in the embodiments of the present disclosure is also referred to as a system-level chip, a system chip, a chip system, or a system-on-chip.

Some embodiments of the present disclosure further provide a computer storage medium for storing at least one computer program. The at least one computer program causes a terminal device to perform the communication method in the embodiments of the present disclosure.

Some embodiments of the present disclosure further provide a computer program product including at least one computer program instruction. The at least one computer program instruction causes a terminal device to perform the communication method in the embodiments of the present disclosure.

In some embodiments, the computer program product is applicable to a terminal device according to some embodiments of the present disclosure, and the at least one computer program instruction causes a computer to perform the corresponding process implemented by the network device in each of the methods according to the embodiments of the present disclosure, which are not repeated herein for brevity.

Some embodiments of the present disclosure further provide at least one computer program. The at least one computer program causes a terminal device to perform the communication method of the embodiments of the present disclosure.

In some embodiments, the at least one computer program is applicable to a terminal device according to some embodiments of the present disclosure. The at least one computer program, when loaded and run on a computer, causes the computer to perform the corresponding process implemented by the network device in each of the methods according to the embodiments of the present disclosure, which are not repeated herein for brevity.

It should be understood by those skilled in the art that the relevant descriptions of the terminal devices, computer storage media, chips, computer program products, and computer programs described above of the embodiments of the present disclosure may be understood with reference to the relevant descriptions of the communication methods according to the embodiments of the present disclosure.

The processor, communication device, or chip according to some embodiments of the present disclosure is an integrated circuit chip with signal processing capability. In implementation, the processes of the method embodiments described above are accomplished by integrated logic circuits of hardware in the processor or instructions in the form of software. The above-described processor, communication device, or chip includes an integration of any one or more of: a general purpose processor, an application-specific integrated circuit (ASIC), a digital signal processor (DSP), a digital signal processing device (DSPD), a programmable logic device (PLD), a field-programmable gate array (FPGA), a central processing unit (CPU), a graphics processing unit (GPU), an embedded neural-network processing units (NPU), a controller, a microcontroller, a programmable logic device, a discrete gate or transistor logic device, and a discrete hardware component. Various methods, processes, and logic block diagrams in the embodiments of the present disclosure are implemented or performed. The general purpose processor is a microprocessor or any conventional processor. The processes of the methods disclosed in conjunction with the embodiments of the present disclosure may be directly embodied as being performed by a hardware decoding processor or performed with a combination of hardware and software modules in the decoding processor. The software module may be disposed in a random memory, a flash memory, a read-only memory, a programmable read-only memory or an electrically erasable programmable memory, a register, or other mature storage media in the art. The storage medium is disposed in a memory, and the processor reads the information in the memory and completes the processes of the method described above in conjunction with its hardware.

It will be appreciated that the memory or computer storage medium in the embodiments of the present disclosure is a volatile memory or a non-volatile memory, or includes both volatile and non-volatile memory. The non-volatile memory is a read-only memory (ROM), a programmable read-only memory (PROM), an erasable programmable read-only memory (EPROM), an electrically erasable programmable read-only memory (EEPROM), or a flash memory. The volatile memory is a random access memory (RAM), which is used as an external cache. By way of illustration, but not limitation, many forms of RAMs are available, such as a static RAM (SRAM), a dynamic RAM (DRAM), a synchronous DRAM (SDRAM), a double data rate SDRAM (DDR SDRAM), an enhanced synchronous SDRAM (ESDRAM), a synchlink DRAM (SLDRAM), and a direct rambus random access memory (DRAM). It should be noted that the memory of the systems and methods described herein is intended to include, but is not limited to, these and any other suitable types of memory.

It should be understood that the above memory or computer storage medium is exemplary but not limiting descriptions. For example, the memory in the embodiments of the present disclosure is an SRAM, a DRAM, an SDRAM, a DDR SDRAM, an ESDRAM, an SLDRAM, a DR RAM, or the like. That is, the memory in the embodiments of the present disclosure is intended to include, but is not limited to, these and any other suitable types of memory.

It should be understood by those skilled in the art that the units and algorithmic processes of the various examples described in the embodiments are capable of being implemented in electronic hardware, or a combination of computer software and electronic hardware. Whether these functions are performed in hardware or software depends on the particular application and design constraints of the technical solution. Those skilled in the art may use different methods to implement the described functions for each particular application, but such implementations should not be considered outside the scope of the present disclosure.

It is clear to those skilled in the art that, for the convenience and brevity of description, the specific working processes of the systems, apparatuses, and units described above may be referred to the corresponding processes in the foregoing embodiments of the methods, and will not be repeated herein.

In the several embodiments according to the present disclosure, it should be understood that the systems, devices, and methods disclosed herein, may be implemented in other ways. For example, the device embodiments described above are merely schematic. For example, the division of the units described above is merely a logical functional division. In practice, division of the units may be implemented in other ways, e.g., a plurality of units or components may be combined or may be integrated into another system, or some features may be ignored, or not implemented. As another point, the coupling or direct coupling or communication connection between each other shown or discussed may be an indirect coupling or communication connection through some interface, device, or unit, which may be electrical, mechanical, or otherwise.

The units illustrated as separated components may or may not be physically separated, and components shown as units may or may not be physical units, i.e., they may be deployed in one place or distributed to a plurality of network units. Some or all of these units may be selected to implement the technical solution according to the embodiments of the present disclosure according to actual needs.

Alternatively, the functional units in various embodiments of the present disclosure may be integrated into one processing unit, or each of the functional units may be physically present separately, or two or more units may be integrated into one unit.

The functionality, when implemented as a software functional unit and sold or used as a separate product, may be stored in a computer-readable storage medium. Based on this understanding, the essence of technical solutions of the present disclosure, the part that contributes to the related art, or the part of the technical solutions, may be embodied in the form of a software product. The computer software product is stored in a storage medium including several instructions to cause a computer device (which may be a personal computer, a server, or a network device) to perform all or some of the processes of the method described in the various embodiments of the present disclosure. The storage medium includes a USB flash drive, a removable hard drive, a ROM, a RAM, a magnetic disc, a compact disc, a CD-ROM, or other media that can store program code.

Described above are merely exemplary embodiments of the present disclosure, but the scope of protection of the present disclosure is not limited to the above description. Any variations and substitutions readily derived by those skilled in the art within the technical scope disclosed in the present disclosure shall fall within the scope of protection of the present disclosure. Therefore, the scope of protection of the present disclosure shall be subject to the scope of protection of the claims.

1. A communication method, comprising:
transmitting, by a terminal device, at least one uplink information on at least one resource;
wherein the at least one resource comprises at least one of: a time domain resource, a frequency domain resource, a code domain resource, or a spatial domain resource; and
wherein the at least one uplink information comprises at least one of: one or more physical uplink control channels (PUCCHs), one or more physical uplink shared channels (PUSCHs), one or more transmission layers, one or more transmission layers corresponding to the PUSCHs, one or more redundancy versions (RVs) corresponding to the PUSCHs, one or more transport blocks, one or more RVs corresponding to the transport blocks, or one or more reference signals.

2. The method according to claim 1, wherein one or more of the following:
the at least one resource is scheduled by one or more downlink control information (DCI), or the at least one resource is configured by higher layer signaling;
different uplink information in the at least one uplink information is associated with different spatial information; wherein the spatial information comprises at least one of: antenna panel information, transmission reception point (TRP) information, control resource set (CORESET) group information, reference signal set information, transmission configuration indication (TCI) state information, beam information, or capability set information; or
the at least one resource comprises at least one of: at least one frequency division multiplexing (FDM) resource, at least one spatial division multiplexing (SDM) resource, at least one code division multiplexing (CDM) resource, or at least one time division multiplexing (TDM) resource.

3. The method according to claim 1, wherein the at least one resource comprises a non-frequency hopping resource.

4. The method according to claim 3, wherein the at least one resource comprises a first resource and a second resource; wherein
the first resource belongs to a first resource set, and the second resource belongs to a second resource set; and
the first resource set and/or the second resource set comprises one or more resource block groups (RBGs), or the first resource set and/or the second resource set comprises one or more resource blocks (RBs).

5. The method according to claim 4, wherein
indexes of the one or more RBGs in the first resource set are smaller than indexes of the one or more RBGs in the second resource set; or
indexes of the one or more RBGs in the first resource set are even numbers, and indexes of the one or more RBGs in the second resource set are odd numbers; or
indexes of a plurality of the RBGs in the first resource set and/or the second resource set are partially consecutive, and a number of contiguous RBGs is at least two; or
indexes of the one or more RBs in the first resource set are smaller than indexes of the one or more RBs in the second resource set; or
indexes of the one or more RBs in the first resource set are even numbers, and indexes of the one or more RBs in the second resource set are odd numbers; or
indexes of a plurality of the RBs the first resource set and/or the second resource set are partially consecutive, and a number of contiguous RBs is at least two.

6. The method according to claim 1, wherein the at least one resource comprises a frequency hopping resource.

7. The method according to claim 6, wherein the at least one resource comprises a first resource and a second resource, wherein the first resource comprises a first frequency hopping resource and a second frequency hopping resource, and the second resource comprises a third frequency hopping resource and a fourth frequency hopping resource; wherein
a starting RB index of the third frequency hopping resource is a sum of a starting RB index of the first frequency hopping resource and a number of RBs of the first frequency hopping resource; and
a starting RB index of the fourth frequency hopping resource is a sum of a starting RB index of the second frequency hopping resource and a number of RBs of the second frequency hopping resource.

8. The method according to claim 7, wherein spatial information associated with the first resource is different from spatial information associated with the second resource;
wherein the spatial information comprises at least one of: panel information, control resource set (CORESET) group information, reference signal set information, transmission configuration indication (TCI) state information, beam information, or capability set information.

9. The method according to claim 7, wherein
a number of RBs of the first frequency hopping resource and/or a number of RBs of the second frequency hopping resource is ┌L_{RB}/2┘, and a number of RBs of the third frequency hopping resource and/or a number of RBs of the fourth frequency hopping resource is ┌L_{RB}/2┐ or is a result of L_{RB} minus the number of RBs of the first frequency hopping resource or the number of RBs of the second frequency hopping resource; or
a number of RBs of the first frequency hopping resource and/or the number of RBs of the second frequency hopping resource is ┌L_{RB}/2┐, and a number of RBs of the third frequency hopping resource and/or a number of RBs of the fourth frequency hopping resource is ┌L_{RB}/2┘ or is a result of L_{RB} minus the number of RBs of the first frequency hopping resource or the number of RBs of the second frequency hopping resource;
wherein L_{RB} represents a total number of RBs allocated to the terminal device.

10. The method according to claim 7, wherein the starting RB index of the first frequency hopping resource is RBₛₜₐᵣₜ; and there is at least one of:
the starting RB index of the second frequency hopping resource is (RBₛₜₐᵣₜ+RB_{offset})modN_{BWP}^{size}, wherein RB_{offset} represents a frequency offset in RBs between frequency hops, and N_{BWP}^{size} represents a number of RBs of uplink activated BWP; the starting RB index of the third frequency hopping resource is RBₛₜₐᵣₜ+┌L_{RB}/2┘ or RBₛₜₐᵣₜ+┌L_{RB}/2┘, wherein L_{RB} represents a total number of RBs allocated to the terminal device; and the starting RB index of the fourth frequency hopping resource is (RBₛₜₐᵣₜ+RB_{offset})modN_{BWP}^{size}+┌L_{RB}/2┘ or (RBₛₜₐᵣₜ+RB_{offset})modN_{BWP}^{size}+┌L_{RB}/2┘; or
the starting RB index of the second frequency hopping resource is (RBₛₜₐᵣₜ+RB_{offset})modN_{BWP}^{size}, wherein RB_{offset} represents a frequency offset in RBs between frequency hops, and N_{BWP}^{size} represents a number of RBs of uplink activated BWP; the starting RB index of the third frequency hopping resource is RBₛₜₐᵣₜ+RB_{offset1}, wherein RB_{offset1} is predefined, indicated by DCI, or indicated by a radio resource control (RRC); and the starting RB index of the fourth frequency hopping resource is (RBₛₜₐᵣₜ+RB_{offset}+RB_{offset1})modN_{BWP}^{size}.

11. A terminal device, comprising:
a processor and a memory configured to store at least one computer program, wherein the at least one computer program, when executed by the processor, causes the terminal device to:
transmit at least one uplink information on at least one resource;
wherein the at least one resource comprises at least one of: a time domain resource, a frequency domain resource, a code domain resource, or a spatial domain resource; and
wherein the at least one uplink information comprises at least one of: one or more physical uplink control channels (PUCCHs), one or more physical uplink shared channels (PUSCHs), one or more transmission layers, one or more transmission layers corresponding to the PUSCHs, one or more redundancy versions (RVs) corresponding to the PUSCHs, one or more transport blocks, one or more RVs corresponding to the transport blocks, or one or more reference signals.

12. A network device, comprising:
a processor and a memory configured to store at least one computer program, wherein the at least one computer program, when executed by the processor, causes the network device to:
receive at least one uplink information on at least one resource;
wherein the at least one resource comprises at least one of: a time domain resource, a frequency domain resource, a code domain resource, or a spatial domain resource; and
wherein the at least one uplink information comprises at least one of: one or more physical uplink control channels (PUCCHs), one or more physical uplink shared channels (PUSCHs), one or more transmission layers corresponding to the PUCCHs, one or more transmission layers corresponding to the PUSCHs, one or more redundancy versions (RVs) corresponding to the PUSCHs, one or more transport blocks, one or more RVs corresponding to the transport blocks, or one or more reference signals.

13. The network device according to claim 12, wherein the at least one resource comprises a non-frequency hopping resource.

14. The network device according to claim 13, wherein the at least one resource comprises a third resource and a fourth resource; wherein
the third resource belongs to a third resource set, and the fourth resource belongs to a fourth resource set; and
the third resource set and/or the fourth resource set comprises one or more resource block groups (RBGs), or the third resource set and/or the fourth resource set comprises one or more resource blocks (RBs).

15. The network device according to claim 14, wherein:
indexes of the one or more RBGs in the third resource set are smaller than indexes of the one or more RBGs in the fourth resource set; or
indexes of the one or more RBGs in the third resource set are even numbers, and indexes of the one or more RBGs in the fourth resource set are odd numbers; or
indexes of a plurality of the RBGs in the third resource set and/or the fourth resource set are partially consecutive, and a number of contiguous RBGs is at least two; or
indexes of the one or more RBs in the third resource set are smaller than indexes of the one or more RBs in the fourth resource set; or
indexes of the one or more RBs in the third resource set are even numbers, and indexes of the one or more RBs in the fourth resource set are odd numbers; or
indexes of a plurality of the RBs in the third resource set and/or the fourth resource set are partially consecutive, and a number of contiguous RBs is at least two.

16. The network device according to claim 12, wherein the at least one resource comprises a frequency hopping resource.

17. The network device according to claim 16, wherein the at least one resource comprises a third resource and a fourth resource, wherein the third resource comprises a fifth frequency hopping resource and a sixth frequency hopping resource, and the fourth resource comprises a seventh frequency hopping resource and an eighth frequency hopping resource; wherein
a starting RB index of the seventh frequency hopping resource is a sum of a starting RB index of the fifth frequency hopping resource and a number of RBs of the fifth frequency hopping resource; and
a starting RB index of the eighth frequency hopping resource is a sum of a starting RB index of the sixth frequency hopping resource and a number of RBs of the sixth frequency hopping resource.

18. The network device according to claim 17, wherein spatial information associated with the third resource is different from spatial information associated with the fourth resource,
wherein the spatial information comprises at least one of: panel information, control resource set (CORESET) group information, reference signal set information, transmission configuration indication (TCI) state information, beam information, or capability set information.

19. The network device according to claim 17, wherein:
a number of RBs of the fifth frequency hopping resource and/or a number of RBs of the sixth frequency hopping resource is ┌L_{RB}/2┘, and a number of RBs of the seventh frequency hopping resource and/or a number of RBs of the eighth frequency hopping resource is ┌L_{RB}/2┘ or a result of L_{RB} minus a number of RBs of the fifth frequency hopping resource or a number of RBs of the sixth frequency hopping resource; or
a number of RBs of the fifth frequency hopping resource and/or the number of RBs of the sixth frequency hopping resource is ┌L_{RB}/2┐, and a number of RBs of the seventh frequency hopping resource and/or a number of RBs of the eighth frequency hopping resource isr┌L_{RB}/2┘, or is a result of L_{RB} minus the number of RBs of the fifth frequency hopping resource or the number of RBs of the sixth frequency hopping resource;
wherein the L_{RB} represents a total number of RBs allocated to a terminal device.

20. The network device according to claim 17, wherein the starting RB index of the fifth frequency hopping resource is RBₛₜₐᵣₜ; and there is at least one of:
the starting RB index of the sixth frequency hopping resource is (RBₛₜₐᵣₜ+RB_{offset})modN_{BWP}^{size}, wherein RB_{offset} represents a frequency offset in RBs between frequency hops, and N_{BWP}^{size} represents a number of RBs of uplink activated BWP; the starting RB index of the seventh frequency hopping resource is RBₛₜₐᵣₜ+┌L_{RB}/2┘ or RBₛₜₐᵣₜ+┌L_{RB}/2┘, wherein L_{RB} represents a total number of RBs allocated to a terminal device; and the starting RB index of the eighth hopping resource is (RBₛₜₐᵣₜ+RB_{offset})modN_{BWP}^{size}+┌L_{RB}/2┘ or (RBₛₜₐᵣₜ+RB_{offset})modN_{BWP}^{size}+┌L_{RB}/2┘; or
the starting RB index of the sixth frequency hopping resource is (RBₛₜₐᵣₜ+RB_{offset})modN_{BWP}^{size}, wherein RB_{offset} represents a frequency offset in RBs between frequency hops, and NN_{BWP}^{size} represents a number of RBs of uplink activated BWP; the starting RB index of the seventh frequency hopping resource is RBₛₜₐᵣₜ+RB_{offset1}, wherein RB_{offset1} is predefined, indicated by DCI, or indicated by a radio resource control (RRC); and the starting RB index of the eighth frequency hopping resource is (RBₛₜₐᵣₜ+RB_{offset}+RB_{offset1})modN_{BWP}^{size}.
